(19) United States
(12) Patent Application Publication
(10) Pub. No.: US 2019/0025849 A1
(43) Pub. Date: Jan. 24, 2019

(54) ROBOT FOR AUTOMATED IMAGE ACQUISITION

(71) Applicant: 4G SPACE GENIUS INC., Toronto (CA)

(72) Inventor: STARK Dean, Toronto (CA)

(73) Assignee: 4G SPACE GENIUS INC., Toronto (CA)

(21) Appl. No.: 16/068,859

(22) PCT Filed: Jan. 9, 2017
(86) PCT No.: PCT/CA2017/050022

§ 371 Date: Jul. 9, 2018

Related U.S. Application Data
(60) Provisional application No. 62/276,455, filed on Jan. 8, 2016.

(51) Int. Cl. G05D 1/02; G05D 1/00; H04N 7/18; H04N 5/369

(52) U.S. Cl. CPC G05D 1/0246; G05D 1/0094; G05D 2201/0216; H04N 5/3692; G05D 2201/0207; H04N 7/185

(57) ABSTRACT

Disclosed is a robot for use in acquiring high resolution imaging data. The robot is particularly suited to acquire images indoors—for example in a retail or warehouse premises. Acquired images may be analyzed to identify inventory and the like. The robot includes a conveyance for moving the robot along a path. The robot captures, using a line scan camera, a series of images of objects along the path as the robot moves. A controller controls the locomotion of the robot and the acquisition of individual images through the camera. Each individual acquired image of the series of images has at least one vertical line of pixels. The series of images may be combined to create a combined image having an expanded resolution. The number of pixels per linear unit of movement may be controlled by the controller, in dependence on the speed of motion of the robot.

### CROSS-REFERENCE TO RELATED APPLICATION

This application claims priority from U.S. Provisional Patent Application No. 62/276,455, filed on Jan. 8, 2016, the entire contents of which are hereby incorporated by reference herein.

### FIELD

This disclosure relates to the automated acquisition of high resolution images, and more particularly, to a robot and software that may be used to collect such images. The acquired images may be indoor images, acquired for example—in retail or warehouse premises. The images may be analyzed to extract data from barcodes and other product identifiers to identify the product and the location of shelved or displayed items.

### BACKGROUND

Retail stores and warehouses stock multiple products in shelves along aisles in the stores/warehouses. However, as stores/warehouses increase in size it becomes more difficult to manage the products and shelves effectively. For example, retail stores may stock products in an incorrect location, misprice products, or fail to stock products available in storage in consumer-facing shelves. In particular, many retailers are not aware of the precise location of products within their stores, departments, warehouses, and so forth.

Retailers traditionally employ store checkers and perform periodic audits to manage stock, at great labor expense. In addition, management teams have little visibility regarding the effectiveness of product-stocking teams, and have little way of ensuring that stocking errors are identified and corrected.

Accordingly, there remains a need for improved methods, software and devices for collecting information associated with shelved items at retail or warehouse premises.

### SUMMARY

In one aspect, there is provided a robot comprising a conveyance apparatus for moving the robot along a path; a line scan camera mounted to the robot and configured to move as the robot moves; and a controller communicatively coupled to the conveyance apparatus and to the line scan camera and configured to control the robot to move, using the conveyance apparatus, along the path, capture, using the line scan camera, a series of images of objects along the path as the robot moves, each image of the series of images having at least one vertical line of pixels, and control the speed of the robot and the line scan camera, to acquire in excess of a predefined number of vertical lines of pixel per linear unit of movement of the robot along the path, to allow the images to be combined to form a combined image having a horizontal pixel density greater than a predefined pixel density.

In another aspect, there is provided a robot comprising a conveyance apparatus for moving the robot along a path; a line scan camera mounted to the robot and configured to move as the robot moves; a focus apparatus having a first mirror, a second mirror opposing the first mirror and defining an optical cavity therein, and a third mirror angled to direct light to the line scan camera and disposed between the first mirror and the second mirror, wherein at least one of the mirrors is movable to alter the path of the light travelling from the objects along the path to the line scan camera; and a controller communicatively coupled to the conveyance apparatus, the line scan camera, and the focus apparatus, and configured to control the robot to move, using the conveyance apparatus, along the path, capture, using the line scan camera, a series of images of objects along the path as the robot moves, the objects along the path being at varying distances from the line scan camera, and control the movable mirror to maintain a substantially constant working distance between the line scan camera and the objects adjacent to the path as the robot moves.

In another aspect, there is provided a robot comprising a conveyance for moving the robot along a path; a line scan camera mounted to the robot and configured to move as the robot moves; and a controller communicatively coupled to the conveyance and to the line scan camera and configured to control the robot to move, using the conveyance, along the path, capture, using the line scan camera, a series of sequences of images of objects along the path as the robot moves, each image of each of the sequences of images having one of a plurality of predefined exposure values, the predefined exposure values varying between a high exposure value and a low exposure value, for each of the sequences of images, select an image of the sequence having no saturated pixels, to obtain a series of selected images, and combine the series of selected images to create a combined image of the objects adjacent to the path.

In another aspect, there is provided a method for capturing an image using a line scan camera coupled to a robot, the method comprising controlling the robot to move, using a conveyance, along a path; capturing, using the line scan camera, a series of images of objects along the path as the robot moves, each image of the series of images having at least one vertical line of pixels; and controlling the speed of the robot and the line scan camera, to acquire in excess of a predefined number of vertical lines of pixels per linear unit of movement of the robot along the path, to allow the images to be combined to form a combined image having a horizontal pixel density greater than a predefined pixel density.

In another aspect, there is provided a robot comprising a conveyance apparatus for moving the robot along a path; a line scan camera mounted to the robot and configured to move as the robot moves and to capture a series of images of objects along the path as the robot moves; a focus apparatus having a first mirror, a second mirror opposing the first mirror to define an optical cavity therein and positioned to receive light from the objects along the path and to redirect the light to the first mirror, and a third mirror disposed between the first mirror and the second mirror and angled to receive the light from the first mirror and to redirect the light to the line scan camera, and wherein the focus apparatus extends a working distance between the line scan camera and the objects adjacent to the path; and a controller communicatively coupled to the conveyance apparatus and the line scan camera and configured to control the robot to move, using the conveyance apparatus, along the path, and capture, using the line scan camera, a series of images of objects along the path as the robot moves.

Other features will become apparent from the drawings in conjunction with the following description.

### BRIEF DESCRIPTION OF THE DRAWINGS

In the figures which illustrate example embodiments,

FIG. 1 is a front plan view and a side plan view of a robot, exemplary of an embodiment;

FIG. 2 is a schematic block diagram of the robot of FIG. 1;

FIGS. 3A-3B illustrate a first example focus apparatus for use with the robot of FIG. 1;

FIGS. 4A-4C illustrate a second example focus apparatus for use with the robot of FIG. 1;

FIG. 5A is a perspective view of the robot of FIG. 1 in a retail store;

FIG. 5B is a top schematic view of a retail store and an example path in the retail store followed by the robot of FIG. 1;

FIG. 5C is a perspective view of the retail intelligence robot of FIG. 1 in a retail store following the path of FIG. 5B;

FIGS. 5D-5F are schematics of example series of images that may be captured by the retail intelligence robot of FIG. 1 in a retail store along the path of FIG. 5B;

FIGS. 6A-6D are top schematic views of components of an exemplary imaging system used in the robot of FIG. 1;

FIGS. 7A-7C are flowcharts depicting exemplary blocks that may be performed by software of the robot of FIG. 1;

FIG. 8 illustrates an exemplary exposure pattern which the robot of FIG. 1 may utilize in acquiring images; and

FIG. 9 is a flowchart depicting exemplary blocks to analyze images captured by the robot of FIG. 1.

### DETAILED DESCRIPTION

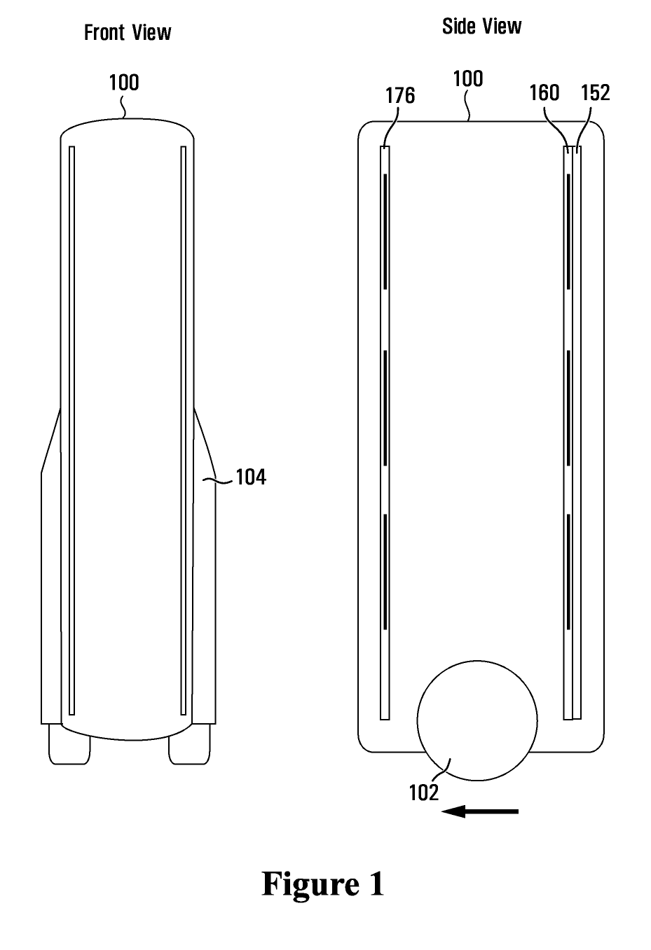

FIG. 1 depicts an example robot 100 for use in acquiring high resolution imaging data. As will become apparent, robot 100 is particularly suited to acquire images indoors—for example in retail or warehouse premises. Conveniently, acquired images may be analyzed to identify and/or locate inventory, shelf labels and the like. As shown, robot 100 is housed in housing 104 and has two or more wheels 102 mounted along a single axis of rotation to allow for conveyance of robot 100. Robot 100 may also have additional third (and possibly fourth) wheels mounted on a second axis of rotation. Robot 100 may maintain balance using known balancing mechanisms. Alternatively, robot 100 may convey using three or more wheels, tracks, legs, or other conveyance mechanisms.

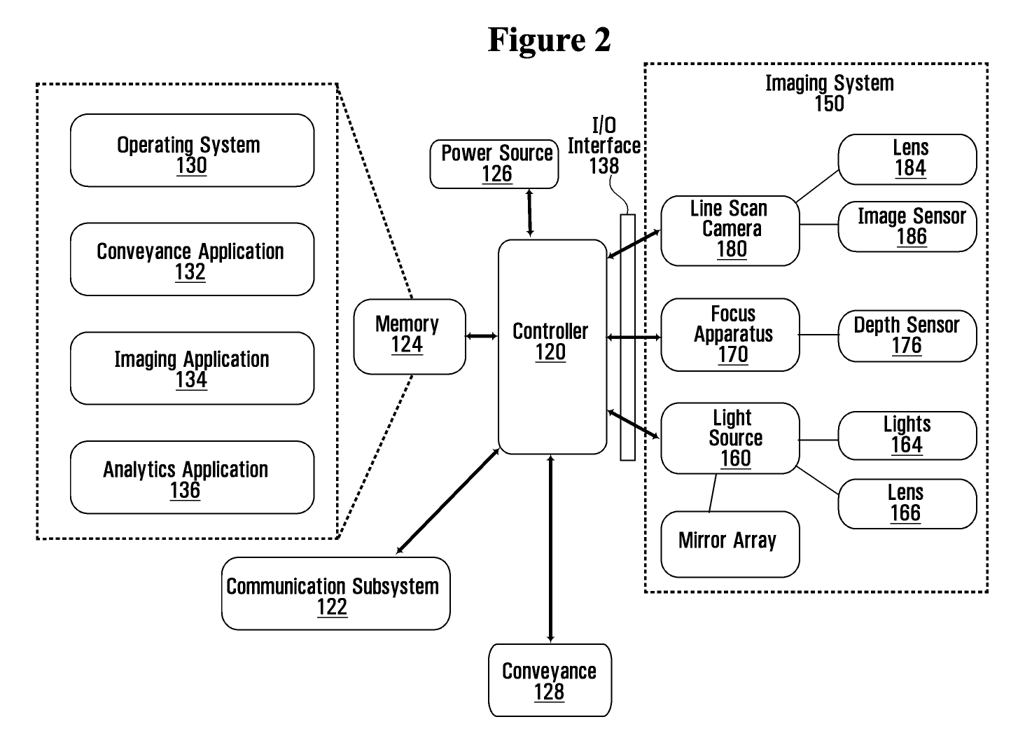

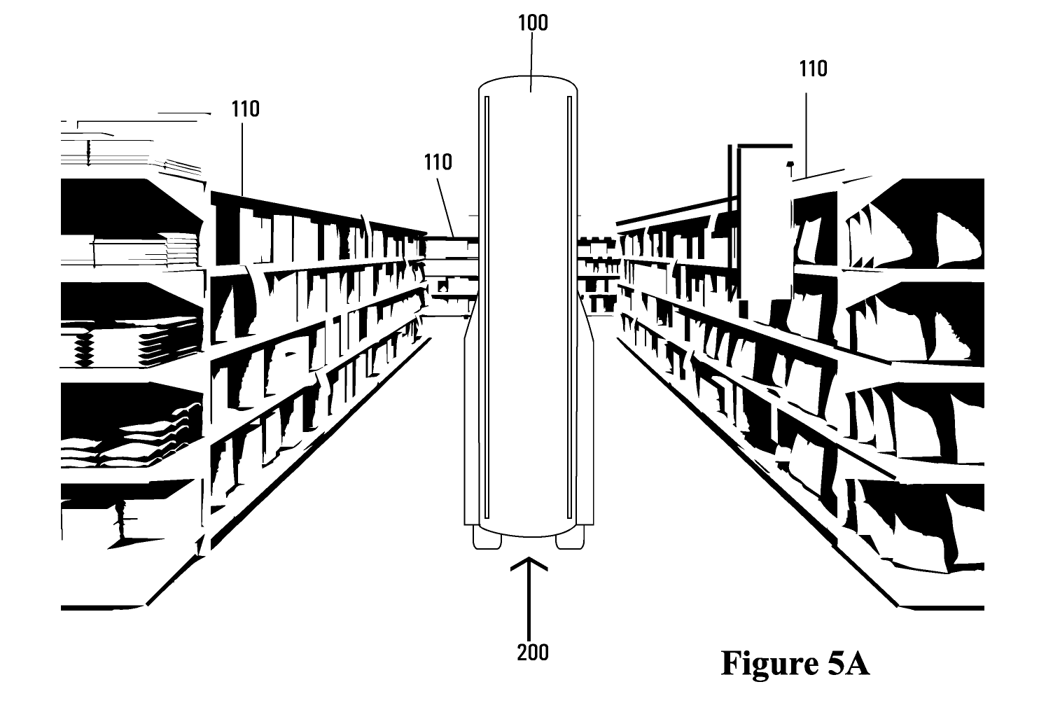

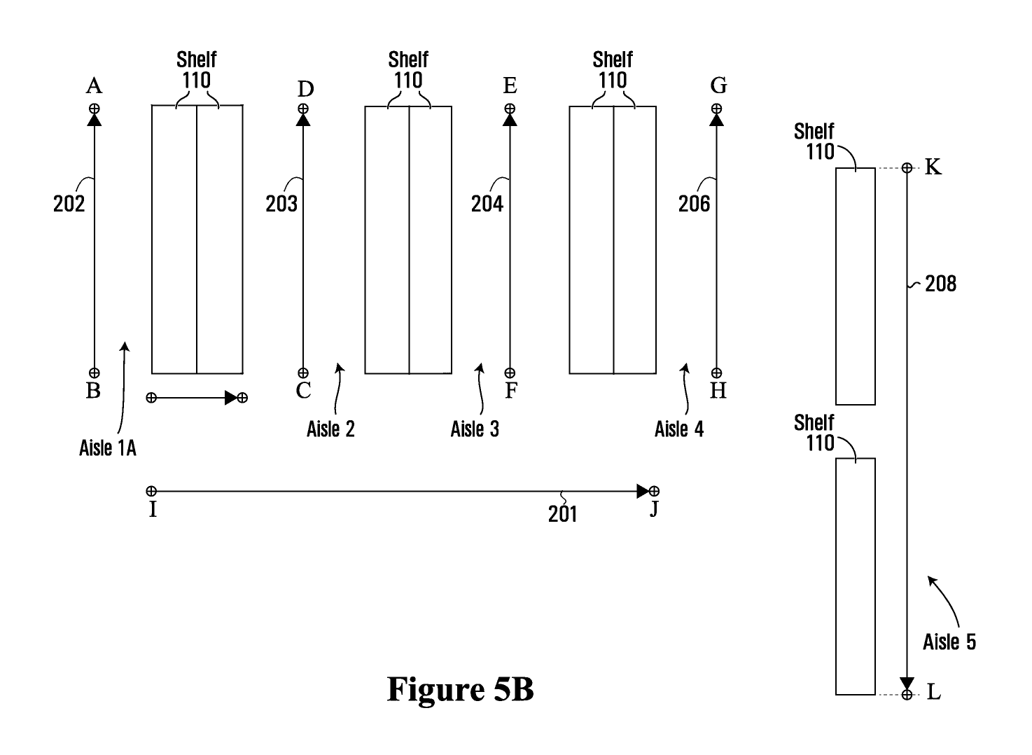

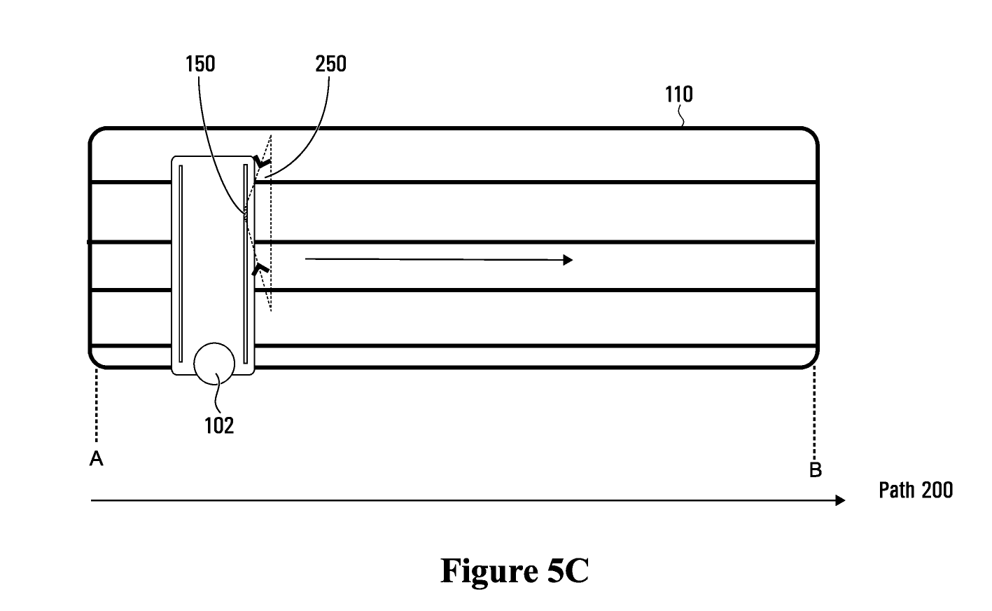

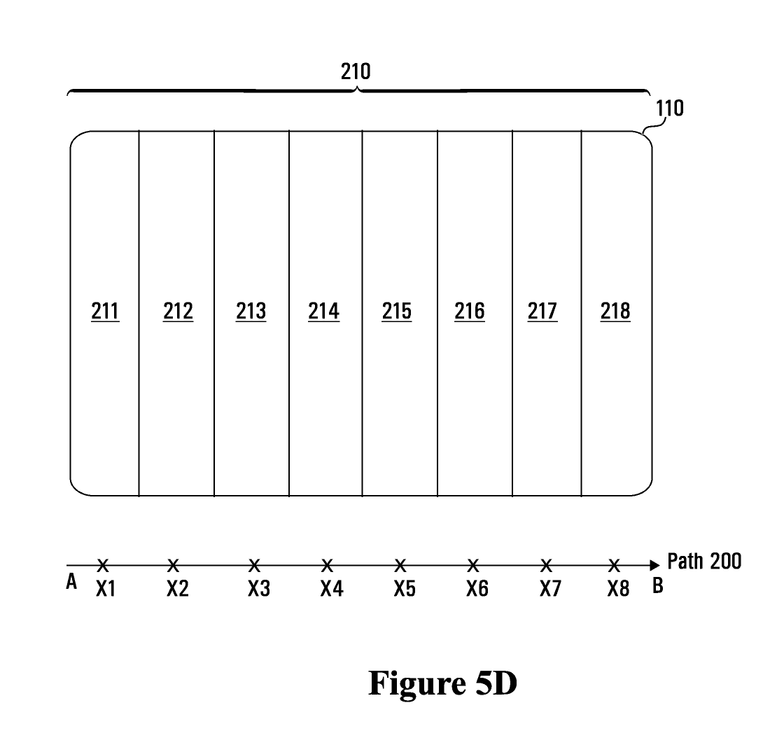

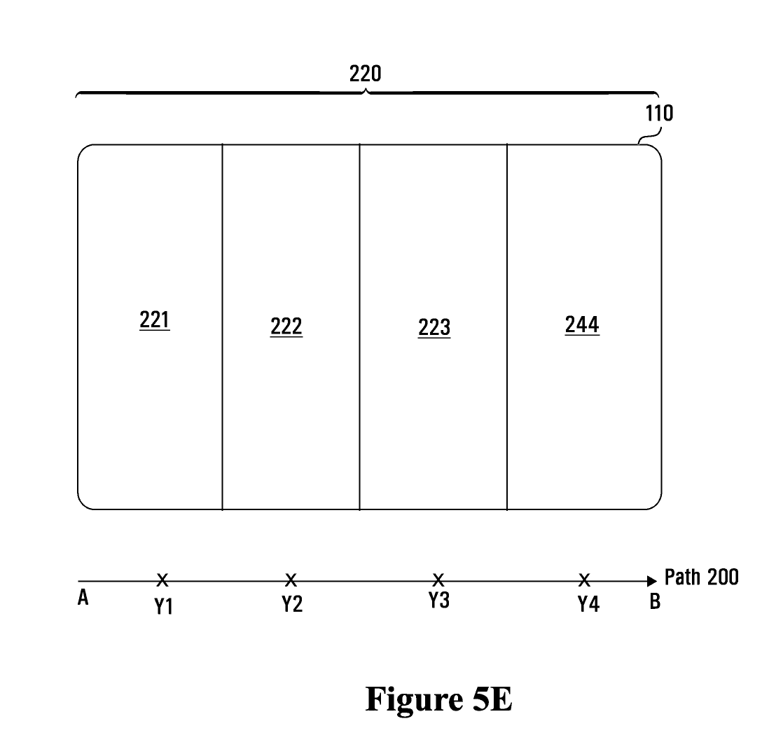

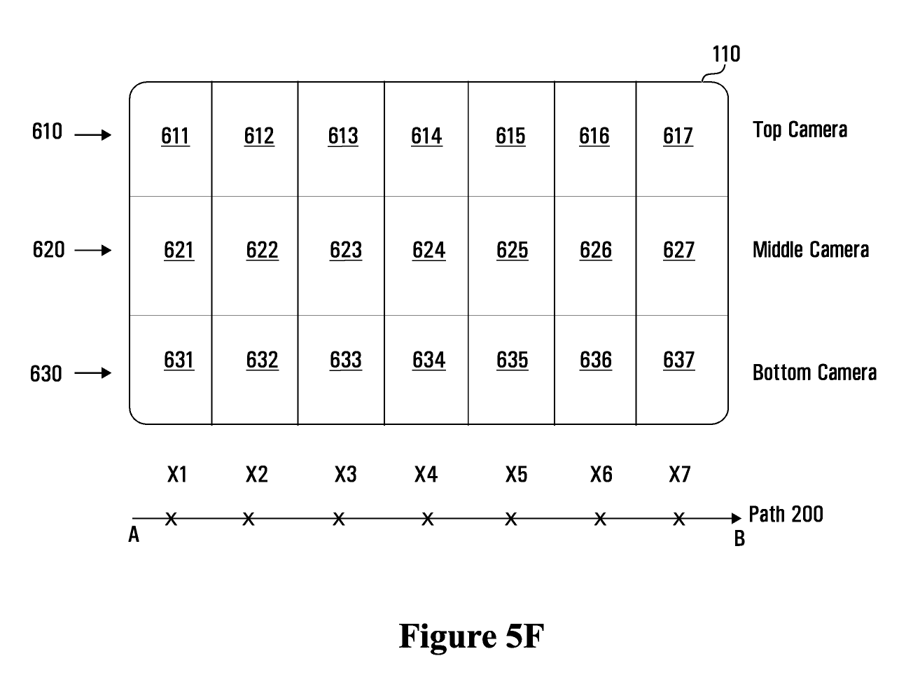

As illustrated in FIG. 2, robot 100 includes a conveyance apparatus 128 for moving robot 100 along a path 200 (depicted in FIG. 5A). Robot 100 captures, using imaging system 150 on robot 100, a series of images of objects along one side or both sides of path 200 as robot 100 moves. A controller 120 controls the locomotion of robot 100 and the acquisition of individual images through imaging system 150. Each individual acquired image of the series of images has at least one vertical line of pixels. The series of images may be combined to create a combined image having an expanded size. Imaging system 150 therefore provides the potential for a near infinite sized image along one axis of the combined image.

Conveniently, the number of pixels acquired per linear unit of movement may be controlled by controller 120, in dependence on the speed of motion of robot 100. When robot 100 moves at a slow speed, a large number of images of a given exposure may be acquired. At higher speed, fewer images at the same exposure may be acquired. Exposure times may also be varied. The more images available in the series of images, the higher the possible number of pixels per linear unit represented by the combined image. Accordingly, the pixel density per linear unit of path 200 may depend, in part, on the speed of robot 100.

Robot 100 may store its location along path 200 in association with each captured image. The location may, for example, be stored in coordinates derived from the path, and may thus be relative to the beginning of path 200. Absolute location may further be determined from the absolute location of the beginning of path 200, which may be determined by GPS, IPS or relative some fixed landmark, or otherwise. Accordingly, the combined image may then be analyzed to identify features along path 200, such as a product identifier, shelf tag, or the like. Further, the identifier data and the location data may be cross-referenced to determine the location of various products and shelf tags fixture along path 200. In one embodiment, path 200 may define a path along aisles of a retail store, a library, or other interior space. Such aisles typically include shelves bearing tags in the form of one or more. Universal Product Codes (‘UPC’) or other product identifiers identifying products, books, or other items placed on the shelves along the aisles adjacent to path 200. The content of the tags may be identifiable in the high resolution combined image; and thus, may be decoded to allow for further analysis to determine the shelf layout, possible product volumes, and other product and shelf data.

To aid in identifying a particular type of product identifier on a tag, such as the UPC, robot 100 may create the combined image having a horizontal pixel density per linear unit of path 200 that is greater than a predefined pixel density needed to decode the particular type of product identifiers. For example, a UPC is made of white and black bars representing ones and zeros; thus, a relatively low horizontal pixel density is typically sufficient to enable robot 100 to decode the UPC. However, for identifying text, a higher horizontal pixel density may be required. Accordingly, the predefined horizontal pixel density may be defined in dependence on the type of product identifier that robot 100 is configured to analyze. Since the horizontal pixel density per linear unit of path 200 of the combined image may depend, in part, on the speed of robot 100 along path 200, robot 100 may control its speed in dependence on the type of product identifier that will be analyzed.

Robot 100 (FIG. 1) also includes imaging system 150 (FIG. 2). At least some components of imaging system 150 may be mounted on a chasis that is movable by robot 100. The chasis may be internal to robot 100; accordingly, robot 100 may also include a window 152 to allow light rays to reach imaging system 150 and to capture images. Furthermore, robot 100 may have a light source 160 mounted on a side thereof to illuminate objects for imaging system 150. Light from light source 160 reaches objects adjacent to robot 100, is (partially) reflected back and enters window 152 to reach imaging system 150. Light source 160 may be positioned laterally toward a rear-end of robot 100 and proximate imaging system 150 such that light produced by the light source is reflected to reach imaging system 150. In one embodiment, robot 100 also includes a depth sensor 176 (e.g. a time-of-flight camera) that is positioned near the front-end of robot 100. Depth sensor 176 may receive reflected signals to determine distance. By positioning window 152 near the rear-end of robot 100 and light source 160 and imaging system 150 near the rear-end of robot 100, depth sensor 176 may collect depth data indicative of the distance of objects adjacent to robot 100. The depth data may be relayed to imaging system 150. Since robot 100 moves as it captures images, imaging system 150 may adjust various parameters (such as focus) in preparation for capturing images of the objects, based on the depth data collected by sensor 176.

FIG. 2 is a schematic block diagram of an example robot 100. As illustrated, robot 100 may include one or more controllers 120, a communication subsystem 122, a suitable combination of persistent storage memory 124, in the form of random-access memory and read-only memory, and one or more I/O interfaces 138. Controller 120 may be an Intel x86™, PowerPC™, ARM™ processor or the like. Communication subsystem 122 allows robot 100 to access external storage devices, including cloud-based storage. Robot 100 may also include input and output peripherals interconnected to robot 100 by one or more I/O interfaces 138. These peripherals may include a keyboard, display and mouse. Robot 100 also includes a power source 126, typically made of a battery and battery charging circuitry. Robot 100 also includes a conveyance 128 to allow for movement of robot 100, including, for example a motor coupled to wheels 102 (FIG. 1).

Memory 124 may be organized as a conventional file system, controlled and administered by an operating system 130 governing overall operation of robot 100. OS software 130 may, for example, be a Unix-based operating system (e.g., Linux™′ FreeBSD™, Solaris™, Mac OS X™, etc.), a Microsoft Windows™ operating system or the like. OS software 130 allows imaging system 150 to access controller 120, communication subsystem 122, memory 124, and one or more I/O interfaces 138 of robot 100.

Robot 100 may store in memory 124, through the filesystem, path data, captured images, and other data. Robot 100 may also store in memory 124, through the filesystem, a conveyance application 132 for conveyancing robot 100 along a path, an imaging application 134 for capturing images, and an analytics application 136, as detailed below.

Robot 100 also includes imaging subsystem 150, which includes line scan camera 180. Additionally, imaging system 150 may also include any of a focus apparatus 170 and a light source 160. Robot 100 may include two imaging systems, each imaging system being configured to capture images of objects on an opposite side of robot 100; e.g. a first imaging system configured to capture images of objects to the right of robot 100, and a second configured to capture images of objects to the left of robot 100. Such an arrangement of two imaging systems may allow robot 100 to only traverse path 200 once to capture images of objects at both sides of robot 100. Each imaging system 150 may also include two or more imaging systems stacked on top of one another to capture a wider vertical field of view.

Line scan camera 180 includes a line scan image sensor 186, which may be a CMOS line scan image sensor. Line scan image sensor 186 typically includes a narrow array of pixels. In other words, the resolution of line scan image sensor 186 is typically one pixel or more on either the vertical or horizontal axis, and on the alternative axis, a larger number of pixels—for example between 512 and 4096 pixels. Of course, this resolution may vary in the future. Each line of resolution of the line scan image sensor 186 may correspond to a single pixel, or alternatively, to more than one pixel. In operation, line scan image sensor 186 is either constantly moving in a direction transverse to its longer extent, and the line scan camera 180 captures a series of images 210 of the objects in its field of view 250 (FIGS. 5C-5F). Each image (e.g. image 211, 212, 213 . . . ) in series of images 210 has a side having a resolution of a single pixel and a side having a resolution of multiple pixels. The series of images 210 may then be combined such that each image is placed adjacent to another image in the order the images were captured, thereby creating a combined image having a higher cumulative resolution. The combined image may then be stored in memory 124.

In one example embodiment, a line scan image sensor with a resolution of 1×4096 pixels is used in line scan camera 180. An example line scan image sensor having such a resolution is provided by Basler™ and has the model number Basler racer raL4096-24 gm. The line scan image sensor may be oriented to capture a single column of pixels having 4096 pixels along the vertical axis. The line scan image sensor is thus configured to capture images, each image having at least one column of pixels. The line scan image sensor is then moved along a path, by robot 100, to capture a series of images. Each image of the series of images corresponds to a location of the robot 100 and the imaging system 150 along the path. The series of images may then be combined to create a combined image having a series of columns of pixels and a vertical resolution of 4096 pixels. For example, if 100,000 images are captured and combined, the combined image may have a horizontal resolution of 100,000 pixels and a vertical resolution of 4,096 pixels (i.e. 100,000×4096).

Line scan camera 180 therefore allows for acquisition of a combined image having a high number of pixels/column horizontal resolution. The resolution of the combined image is not limited by the camera itself. Rather, the horizontal pixels density (pixels per linear unit of movement) may depend on the number of images captured per unit time and the speed of movement of robot 100 along path 200. The number of images captured per unit time may further depend on the exposure time of each image.

Path 200 is typically made up of a predefined length, for example, from point ‘A’ to point ‘B’. If robot 100 moves slowly along path 200 a relatively large number of images may be captured between points ‘A’ and ‘B’, compared to a faster moving robot 100. Each captured image provides only a single vertical line of resolution (or few vertical lines of resolution). Accordingly, the maximum speed at which robot 100 may travel may be limited, in part, by the number of vertical lines per linear unit of movement that robot 100 must capture to allow for product identifiers to be decoded.

Furthermore, in addition to providing the high horizontal pixel density, line scan camera 180 may help reduce parallax errors from appearing along the horizontal axis in the combined image. Since each captured image of the series of images has only one or only a few vertical lines of resolution, the images will have a relatively narrow horizontal field of view. The relatively narrow horizontal field of view may result in a reduced amount of parallax errors along the horizontal axis in the combined image as there is a lower chance for distortion along the horizontal axis.

Line scan camera 180 may also be implemented using a time delay integration (‘TDI’) sensor. A TDI sensor has multiple lines of resolution instead of a single line. However, the multiple lines of resolution are used to provide improved light sensitivity instead of a higher resolution image; thus, a TDI sensor may require lower exposure settings (e.g. less light, a shorter exposure time, etc) than a conventional line scan sensor.

In addition, line scan camera 180 includes one or more lenses 184. Line scan camera 180 may include a lens mount, allowing for different lenses to be mounted to line scan camera 180. Alternatively, lens 184 may be fixedly coupled to line scan camera 180. Lens 184 may have either a fixed focal length, or a variable focal length that may be controlled automatically with a controller.

Lens 184 has an aperture to allow light to travel through the lens. Lens 184 focuses the light onto line scan image sensor 186, as is known in the art. The size of the aperture may be configurable to allow more or less light through the lens. The size of the aperture also impacts the nearest and farthest objects that appear acceptably sharp in a captured image. Changing the aperture impacts the focus range, or depth of field (‘DOF’), of captured images (even without changing the focal length of the lens). A wide aperture results in a shallow DOF; i.e. the nearest and farthest objects that appear acceptably sharp in the image are relatively close to one another. A small aperture results in a deep DOF; i.e. the nearest and farthest objects that appear acceptably sharp in the image are relatively far from one another. Accordingly, to ensure that objects (that may be far from one another) appear acceptably sharp in the image, a deep DOF and a small aperture are desirable.

However, a small aperture, which is required for a deep DOF, reduces the amount of light that can reach line scan image sensor 186. To control the exposure of line scan camera 180, controller 120 may vary the exposure time or the sensitivity of image sensor 186 (i.e. the ISO). Additionally, imaging system 150 may also include a light source 160, such as a light array or an elongate light source, which has multiple light elements. In operation, controller 120 may be configured to activate the light source 160 prior to capturing the series of images to illuminate the objects whose images are being captured.

As shown in FIG. 1, light source 160 is mounted on a side of robot 100 to illuminate objects for imaging system 150. The light elements of the light source may be integrated into housing 104 of robot 100, as shown in FIG. 1, or alternatively, housed in an external housing extending outwardly from robot 100. The light source 160 may be formed as a column of lights. Each light of the array may be an LED light, an incandescent light, a xenon light source, or other type of light element. In other embodiments, an elongate florescent bulb (or other elongate light source) may be used instead of the array. Robot 100 may include a single light source 160, or alternatively more than one light source 160.

Additionally, a lens 166 (or lenses) configured to converge and/or collimate light from light source 160 may be provided. In other words, lens 166 may direct and converge light rays from the light elements of light source 160 onto a field of view of line scan camera 180. By converging and/or collimating the light to the relatively narrow field of view of line scan camera, lower exposure times may be needed for each captured image. To converge and/or collimate light, a single large lens may be provided for all light elements of light source 160 (e.g. an elongate cylindrical lens formed of glass), or an individual lens may be provided for each light element of light source 160.

Additionally, imaging system 150 may also include a focus apparatus 170 to maintain objects positioned at varying distances from lens 184 in focus. Focus apparatus 170 may be controlled by a controller (such as controller 120 (FIG. 2) or a focus controller) based on input from a depth sensor 176, or depth data stored in memory (FIGS. 1 and 2). As noted, depth sensor 176 may be mounted in proximity to lens 184 (for example, on a platform), and configured to sense the distance between the depth sensor and objects adjacent to the robot 100 and adjacent to path 200. Depth sensor 176 may be mounted ahead of lens 184/window 152 in the direction of motion of robot 100. Depth sensor 176 may be a range camera configured to produce a range image, or a time-of-flight camera which emits a light ray (e.g. an infrared light ray) and detects the reflection of the light ray, as is known in the art.

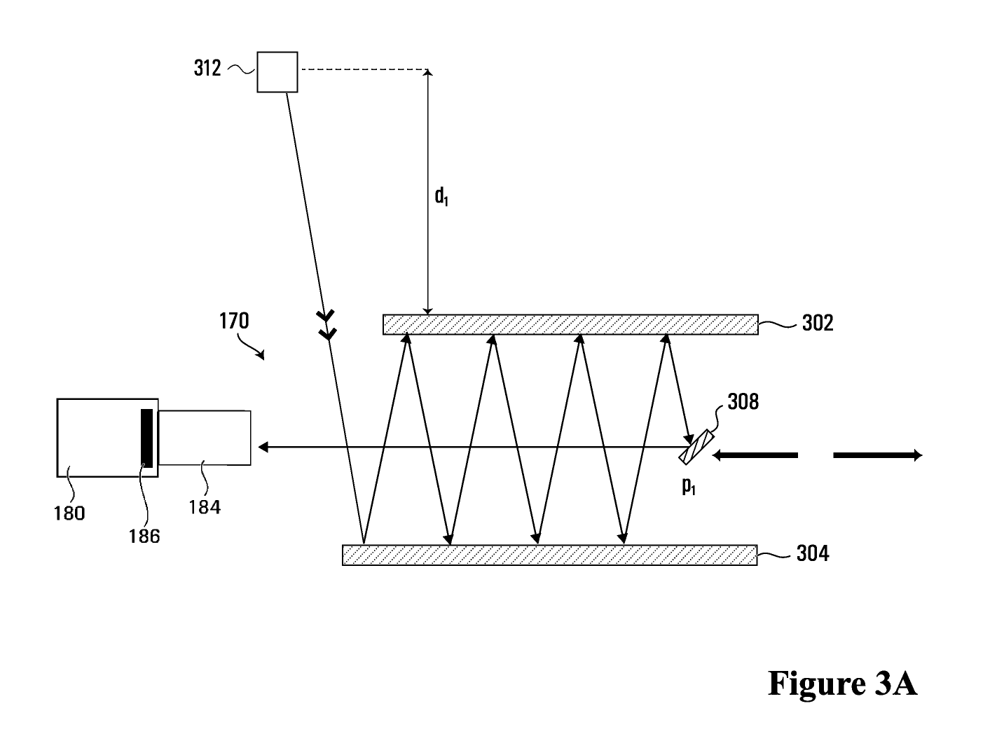

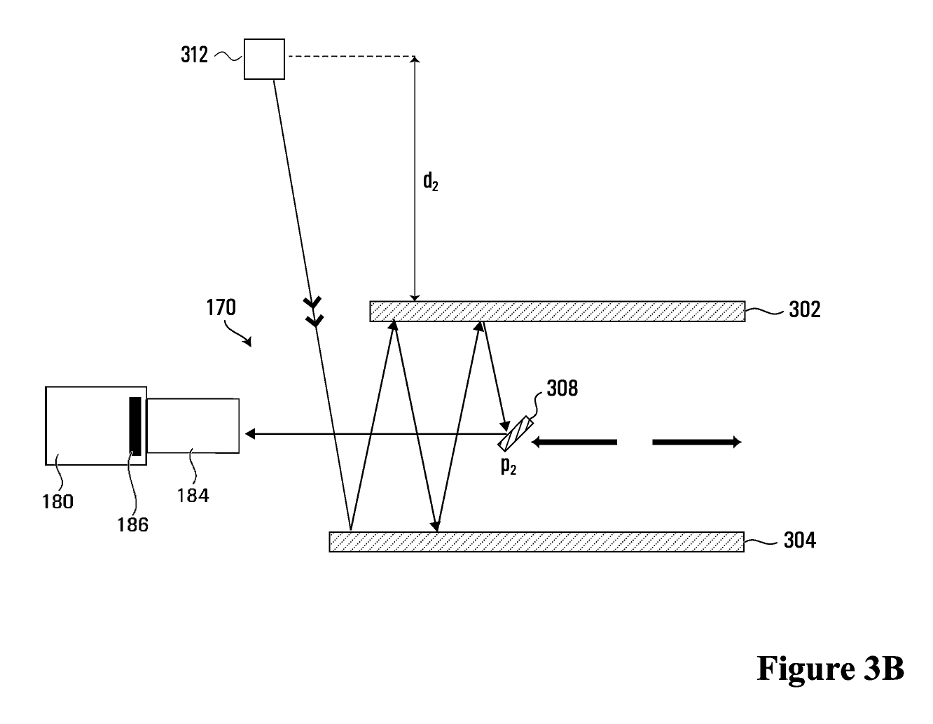

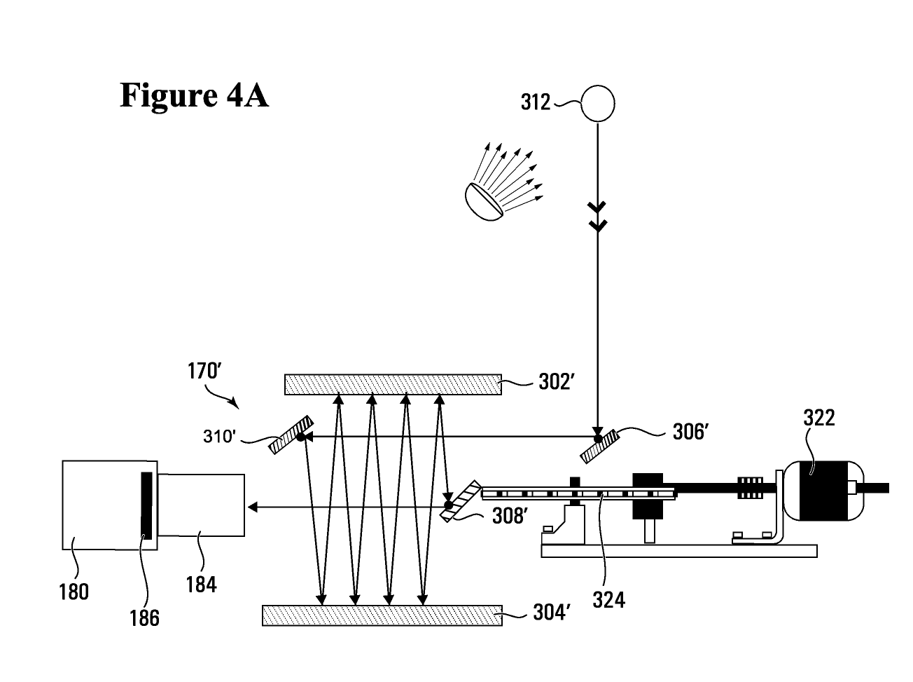

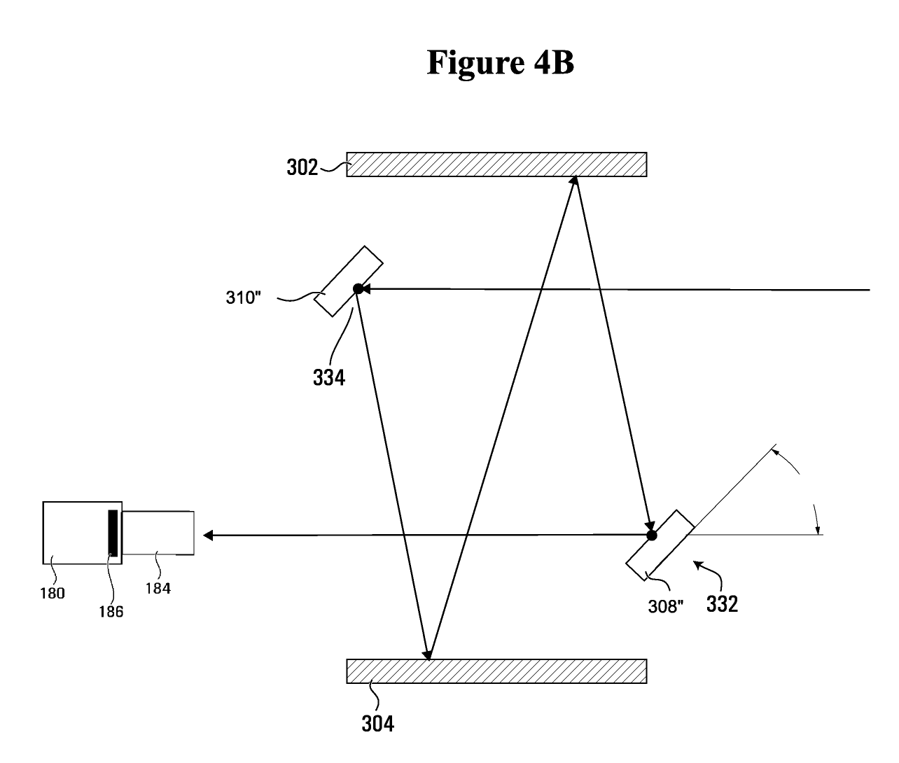

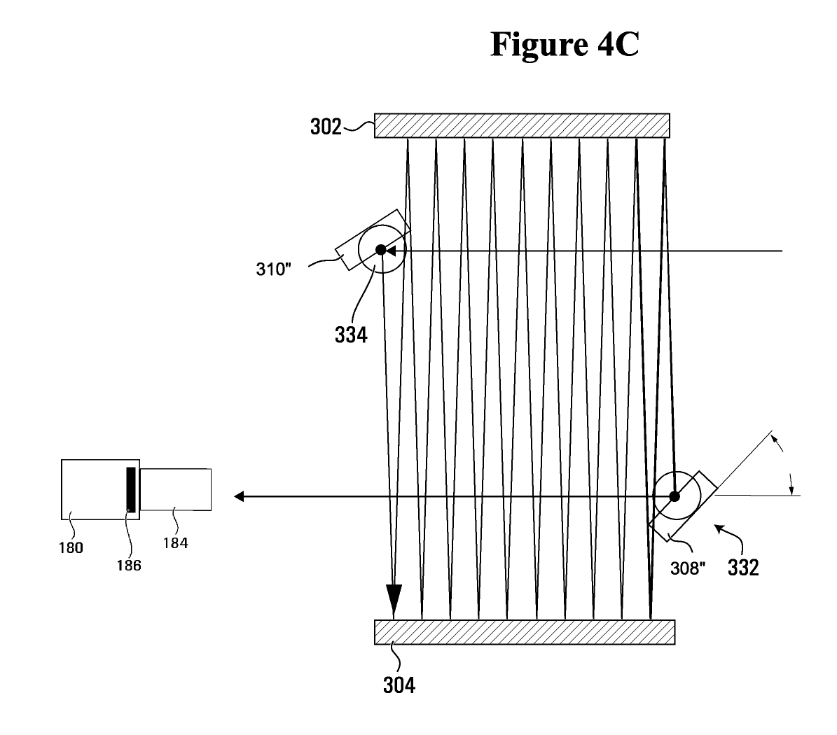

Focus apparatus 170 may be external to lens 184, such that lens 184 has a fixed focal length. FIGS. 3A-3B and 4A-4C, illustrate embodiments of focus apparatus 170 using a lens having a fixed focal length. Instead of adjusting the focal length of lens 184, focus apparatus 170 may, from time to time, be adjusted to maintain the working distance between line scan camera 180 and objects adjacent to the robot 100 and adjacent to path 200 substantially constant. By maintaining the working distance substantially constant, focus apparatus 170 brings the objects in focus at image sensor 186 without varying the focal length of lens 184.

Example focus apparatus 170 includes mirrors 302, 304 and 308 mounted on the chasis of robot 100 and positioned adjacent to line scan camera 180. Objects may be positioned at varying distance from lens 184. Accordingly, to maintain the working distance substantially constant, mirrors 302, 304 and 308 may change the total distance the light travels to reach lens 184 from objects, as will be explained. In addition to maintaining the working distance substantially constant, a further mirror 306 may also change the angle of light before the light enters lens 184. As shown, for example, mirror 306 allows line scan camera 180 to capture images of objects perpendicular to lens 184 (i.e. instead of objects opposed to lens 184). At least one of mirrors 302, 304, 306 and 308 is movable (e.g. attached to a motor). The movable mirror is movable to alter the path of light travelling from objects along path 200 to line scan camera 180; thereby maintaining the working distance between line scan camera 180 and objects adjacent to the robot 100 and adjacent to path 200 substantially constant. Controller 120 may be configured to adjust the location and/or angle of the movable mirror to focus line scan camera 180 on the objects adjacent to the robot 100 and adjacent to path 200 to maintain the working distance substantially constant at various positions along path 200. Controller 120 may adjust the movable mirror based on an output from depth sensor 186.

Shown in FIGS. 3A and 3B are example mirrors 302, 304 and 308. First and second mirrors 302, 304 oppose one another, and define an optical cavity therein. Third mirror 308 is disposed in the optical cavity in between first and second mirrors 302, 304. Light entering the optical cavity may first be incident on first and second mirrors 302, 304, and then may be reflected between first and second mirrors 302, 304 in a zigzag within the optical cavity. The light may then be incident on third mirror 308 which may reflect the light onto image sensor 186 through lens 184.

As shown in FIGS. 3A and 3B mirrors 302, 304 and 308 are flat mirrors. However, in other embodiments, curved mirrors may be used.

Adjusting the position of any of mirrors 302, 304, and 308 adjusts the working distance between line scan camera 180 and objects adjacent to robot 100 and adjacent to path 200. Similarly, adjusting the angle of mirror 308 may also allow robot 100 to adjust the working distance. Accordingly, at least one of the distance between first and second mirrors 302, 304, the distance between third mirror 308 and image sensor 186, and the angle of mirror 308 may be adjusted to maintain the working distance substantially constant. A voice coil or a linear motor may be used to adjust the location and/or angle of any one of the mirrors. The voice coil or linear motor may cause anyone of the mirrors to move back-and-forth to a desired position or to rotate about an angle of rotation.

To focus on object 312, the working distance (i.e. the path which the light follows through focus apparatus 170) should correspond to the focal length of the lens. Since the focal length of lens 184 may be fixed as robot 100 moves along path 200, the length of the path which the light follows from the object should remain substantially constant even if object are at varying distances from the lens 184. Accordingly, moving third mirror 308 further or closer to image sensor 186 can ensure that the length of the working distance remains substantially constant even when object is at a further or closer physical distance.

An example is shown in FIGS. 3A-3B. Focus apparatus 170 may be configured to bring object 312 in focus while object 312 is at either distance d1 (FIG. 3A) or distance d2 (FIG. 3B) from the imaging system. In FIG. 3A, imaging system 150 is configured to focus on object 312 at distance d1 by maintaining third mirror 308 at position P1. In FIG. 3B, imaging system 150 is configured to focus on object 312 at distance d2 by maintaining third mirror 308 at position P2. Since distance d2 is further away from the imaging system than distance d1, focus apparatus 170 compensates by moving third mirror 308 from position P1 to position P2 which is closer to image sensor 186 than P1.

An alternate embodiment of focus apparatus 170′ is shown in FIG. 4A. In this embodiment, focus apparatus 170′ includes five mirrors, first mirror 302′, second mirror 304′, third mirror 306′, fourth mirror 308′, and fifth mirror 310′. As before, first and second mirrors 302′, 304′ oppose one another, and define an optical cavity therein. Third and fourth mirrors 306′, 310′ are opposed to one another, and are angled such that third mirror 306′ can receive light from object 312′, and then reflect the received light through the optical cavity to fifth mirror 310′. Light received at fifth mirror 310′ is then reflected to second mirror 304′, and then reflected back and forth between first and second mirrors 302′, 304′ until the light is incident on fourth mirror 308′. Light incident at fourth mirror 308′ is reflected through the optical cavity onto image sensor 186 through lens 184. Fourth mirror 308′ is coupled to motor 322 by plunger 324 which allows controller 120 to control movement of fourth mirror 308′ along the optical cavity, and may also allow for controller 120 to control the angle of fourth mirror 308′.

As shown in FIG. 4A mirrors 302′, 304′, 306′, 308′, and 310′ are flat mirrors. However, in other embodiments, curved mirrors may be used.

Accordingly, adjusting the position of any of mirrors 302′, 304′, and 308′ adjusts the working distance between line scan camera 180 and objects adjacent to robot 100 and adjacent to path 200. Similarly, adjusting the angle of mirrors 308′ and 310′ may also allow robot 100 to adjust the working distance. Accordingly, at least one of the distance between first and second mirrors 302′, 304′, the distance between third mirror 308′ and image sensor 186, and the angle of mirrors 308′ and 310′ may be adjusted to maintain the working distance substantially constant. Mirror 306′ may also be adjusted to maintain the working distance and vary the viewing angle of camera 180. A voice coil or a linear motor may be used to adjust the location and/or angle of any one of the mirrors. The voice coil or linear motor may cause anyone of the mirrors to move back-and-forth to a desired position or to rotate about an angle of rotation.

In yet another embodiment, fourth mirror 308″ and fifth mirror 310″ may be attached to rotary drives 332, and 334 respectively, as shown in FIGS. 4B-4C. Rotary drives 332 and 334 allow controller 120 to adjust the angle of mirrors 308″ and 310″. In FIG. 4B, the mirrors 308″ and 310″ are positioned at a first angle, and, in FIG. 4C, at a second angle. As shown, the path the light takes in FIG. 4B is shorter than the path the light takes in FIG. 4C. By changing the distance the light must travel to reach line scan camera 180, the focus apparatus 170 maintains the working distance between line scan camera 180 and the objects adjacent to path 200 substantially constant.

In addition to providing a focus mechanism, focus apparatus 170 may also extend the working distance between line scan camera 180 and the objects adjacent to path 200. For example, as shown in FIGS. 3A-3B, light from object 312 is not directed to line scan camera 180 directly. As shown, second mirror 304 receives light from object 312 and is positioned to direct the light to first mirror 302. Similarly, third mirror 308 is angled to receive the light from first mirror 302 and to redirect the light to line scan camera 180. The extended path the light takes via mirrors 302, 304, and 308 to reach line scan camera 180 results in an extended working distance. The effect of extending the working distance is optically similar to stepping back when using a camera.

As is known in the art, a wide-angle lens (e.g. a fish-eye lens having a focus length of 20 to 35 mm) is typically required to focus and image objects positioned in proximity to a camera (e.g. within 6 to 10 inches to the camera). However, in the depicted embodiments of FIGS. 3A-4C, as a result of the extended working distance provided by focus apparatus 170, robot 100 may be positioned in proximity to shelves 110 (FIGS. 5A-5F) without the use of a wide-angle lens. Instead, a telephoto lens (e.g. a lens having a focus length of 80 to 100 mm) may be used in combination with focus apparatus 170. This is because focus apparatus 170 creates, optically, an extended distance between object 312 and lens 184. Further, in some embodiments, the use of a wide-angle lens may result in optical distortion (e.g. parallax errors). Accordingly, by using a tele-photo lens, such optical distortion may be reduces. While some wide-angle lenses provide a relatively reduced amount of optical distortion, such lenses are typically costly, large, and heavy.

The field-of-view resulting from the use of focus apparatus 170 in combination with a tele-photo lens may be adjusted such that it is substantially similar to the field of view resulting from the use of a wide-angle lens (without focus apparatus 170). Further, in some embodiments, the field-of-view may be maintained substantially the same when using different lenses with line scan camera 180 by adjusting or moving an adjustable or movable mirror of focus apparatus 170. In one example, a vertical field-of-view of 24 inches is desirable. Accordingly, after selecting an optimal lens for use with line scan camera 180, robot 100 may adjust or move an adjustable or movable mirror of focus apparatus 170 to achieve a vertical field-of-view of 24 inches.

As shown in FIGS. 5A-5F, robot 100 moves along path 200 and captures, using imaging system 150, a series of images 210 of objects along path 200 (FIG. 5D), for example in a retail store. As shown in FIG. 5B, path 200 may be formed as a series of path segments adjacent to shelving units in a retail store to allow robot 100 to traverse the shelving units of the store. Alternatively, path 200 may include a series of path segments adjacent to shelving units in other environments, such as libraries and other interior spaces.

For example, robot 100 may traverse shelving units of a retail store, which may have shelves 110 on each side thereof. As robot 100 moves along path 200, imaging system 150 of robot 100 captures a series of images 210 of shelves 110 and the objects placed thereon. Each image of the series of images 210 corresponds to a location of the imaging system along path 200. The captured series of images 210 may then be combined (e.g. by controller 120 of robot 100, another controller embedded inside robot 100, or by a computing device external to robot 100) to create a combined image of the objects adjacent to path 200; e.g. shelves 110, tags thereon and objects on shelves 110.

FIG. 5B illustrates an example path 200 formed as a series of path portions 201, 202, 203, 204, 206 and 208 used in an example retail store having shelves 110. As shown, path 200 includes path portion 202 for traversing Aisle 1 from point ‘A’ to point ‘B’; path portion 203 for traversing Aisle 2 from point ‘C’ to point D′; path portion 204 for traversing Aisle 3 from point ‘E’ to point ‘F’; path 206 for traversing Aisle 4 from point ‘H’ to point ‘G’; path portion 208 for traversing Aisle 5 from point ‘K’ to point ‘L’; and path portion 201 for traversing the side shelves of Aisle 1, Aisle 2, Aisle 3, and Aisle 4 from point ‘J’ to point ‘I’. As shown, each path portion defines a straight line having defined start and end points. Conveniently, robot 100 may capture images on either side of each aisle simultaneously. Robot 100 may follow similar path portions to traverse shelves in a retail store or warehouse. The start and end points of each path portion of path 200 may be predefined using coordinates and stored in memory 124, or alternatively, robot 100 may define path 200 as it traverses shelves 110, for example, by detecting and following markings on the floor defining path 200.

As illustrated in FIG. 5A, robot 100 may have two imaging systems 150, with each imaging system configured to capture images from a different side of the two sides of the robot 100. Accordingly, if robot 100 has shelves 110 on each side thereof, as in Aisles 2, 3, and 4 of FIG. 5B, robot 100 can capture two series of images simultaneously using each of the imaging systems. Robot 100 therefore only traverses path 200 once to capture two series of images of the shelves 110, one of each side (and the objects thereon).

To navigate robot 100 across path 200, controller 120 may implement any number of navigation systems and algorithms. Navigation of robot 100 along path 200 may also be assisted by a person and/or a secondary navigation system. One example navigation system includes a laser line pointer for guiding robot 100 along path 200. The laser line pointer may be used to define path 200 by shining a beam along the path from far away (e.g. 300 feet away) that may be followed. The laser-defined path may be used in a feedback loop to control the navigation of robot 100 along path 200. To detect such deviations, robot 100 may include at the back thereof a plate positioned at the bottom end of robot 100 near wheels 102. The laser line pointer thus illuminates the plates. Any deviation from the center of the plate may be detected, for example, using a camera pointed towards the plate. Alternatively, deviations from the center may be detected using two or more horizontally placed light sensitive linear arrays. Furthermore, the plate may also be angled such that the bottom end of the plate protrudes upwardly at a 30-60 degree angle. Such a protruding plate emphasizes any deviation from path 200 as the angle of the laser beam will be much larger than the angle of the deviation. The laser beam may be a modulated laser beam, for example, pulsating at a preset frequency. The pulsating laser beam may be more easily detected as it is easily distinguishable from other light.

Reference is now made to FIG. 5C, which illustrates an example field of view 250 of imaging system 150. As illustrated, field of view 250 is relatively narrow along the horizontal axis and relatively tall along the vertical axis. As previously explained, the relatively narrow horizontal field of view is a result of the using a line scan camera in the imaging system. Field of view 250 may depend, in part, on the focal length of lens 184 (i.e. whether lens 184 is a wide-angle, normal, or telephoto lens) and the working distance between lens 184 and objects adjacent to the path. By maintaining the working distance substantially constant using focus apparatus 170, as discussed, the field of view 250 also remains substantially constant as robot 100 traverses path 200.

Reference is now made to FIGS. 5D-E, which illustrate example series of images 210 and 220, respectively, which may be captured by robot 100 along the portion of path 200 from point ‘A’ to point ‘B’; i.e. path 202. Series of images 210 of FIG. 5D capture the same subject-matter as series of images 220 of FIG. 5E, at different intervals. Each image of series of images 210 corresponds to a location of robot 100 along path 200: at location x1, image 211 is captured; at location x2, image 212 is captured; at location x3, image 213 is captured; at location x4, image 214 is captured; at location x5, image 215 is captured; and so forth. Similarly, each image of series of images 220 corresponds to a location of robot 100 along path 200: at location y1, image 221 is captured; at location y2, image 222 is captured; at location y3, image 223 is captured; and at location y4, image 224 is captured. Controller 120 may combine the series of images 210 to create combined images of the shelves 110 (and other objects) adjacent to path 200. Likewise controller 120 may combine the series of images 220 to create combined images. The series of images are combined at the elongate axis; i.e. the vertical axis, such that the combined image has an expanded resolution along the horizontal axis.

As shown, the combined image of FIG. 5D will have a horizontal resolution along point ‘A’ to point ‘B’ of 8 captured images, whereas the combined image of FIG. 5E has a horizontal resolution along point ‘A’ to point ‘B’ of 4 captured images. Since the distance from point ‘A’ to point ‘B’ in FIGS. 5D-5E is the same, and the resolution of the captured subject-matter is the same, it is apparent that in FIG. 5E the number of images captured per linear unit of movement of robot 100 is half of the number of images captured per linear unit of movement of robot 100 in FIG. 5D. Accordingly, the horizontal pixel density of the combined image of FIG. 5D per linear unit of movement of robot 100 along path 200 is double the horizontal pixel density of the combined image of FIG. 5E. In this example, robot 100 may move at a speed of 1 unit per second to capture series of images 210 of FIG. 5D and at a speed of 2 units per second to capture series of images 220 of FIG. 5E. Alternatively, robot 100 may move at the same speed when capturing both series of images 210, 220, but instead may take twice as long to capture each image of series of images 220 (for example, series of images 220 may be captured using a longer exposure time to accommodate for a lower light environment), thereby capturing fewer images whilst moving at the same speed. As will be appreciated, the resolution of the resulting combined image may thus be varied by varying the speed of robot 108 and exposure of any captured image.

The combined images may be analyzed using image analysis software to produce helpful information for management teams and product-stocking teams. In analyzing the image, the image analysis software benefits from the relatively high resolution images produced by using a line scan camera in imaging system 150. The combined image, for example, may be analyzed (using software analytic tools or by other means) to identify shelf tags, shelf layouts, deficiencies in stocked shelves, including but not limited to, identifying products stocked in an incorrect location, mispriced products, low inventory, and empty shelves, and the like.

To aid in analyzing the combined image to identify and decode product identifiers (such as UPC), the combined image may have a horizontal pixel density per linear unit of path 200 that is greater than a predefined horizontal pixel density. Controller 120 may set the minimum horizontal pixel density based on the type of product identifier that needs to be analyzed. For example, controller 120 may only require a horizontal pixel density per linear unit of path 200 of 230 pixels per inch to decode UPC codes, and 300 pixels per inch to decode text (e.g. using OCR software). Accordingly, controller 120 may identify the minimum required horizontal pixel density per linear unit of path 200 to decode a particular product identifier, and based on the minimum required horizontal pixel density per linear unit of path 200 associated with the product identifier and the time needed to capture each image, determine the number of images required per linear unit of movement of robot 100 to allow the images to be combined to form a combined image having a horizontal pixel density per linear unit of path 200 greater than the predefined pixel density.

For example, to create a combined image having a horizontal pixel density per linear unit of path 200 greater than 230 pixels per inch, robot 100 must capture 230 columns of pixels for every inch of linear movement of robot 100 (as each image provides one vertical line of resolution, the equivalent of 230 such images). Controller 120 may then determine a maximum speed at which robot 100 can move along path 200 to obtain 230 images for every inch of linear movement based on the time needed to capture each image. For example, if the time needed to capture each image is 50 μs (e.g. 45 is exposure time+5 μs reset time), then robot 100 may move at about 2 m per second to capture images at a sufficient rate to allow the images to be combined to form an image having a horizontal pixel density per linear unit of movement along path 200 that is greater than 230 pixels per inch. If a greater horizontal pixel density is needed, then robot 100 may move at a slower speed. Similarly, if a lower horizontal pixel density is needed then robot 100 may move at a faster speed.

Similarly, if a longer time is needed to capture each image, then the maximum speed at which robot 100 may move along path 200 is reduced in order to obtain the same horizontal pixel density per linear unit of path 200. In one example, a sequence of ten images is captured (each image is captured with a different exposure time), and only the image having the optimal exposure of the ten images is used to construct the combined image. If the time to capture the sequence of ten images is 0.5 milliseconds, then robot 100 may move at about 0.20 m per second to capture images at a sufficient rate to allow the images to be combined to form an image having a horizontal pixel density per linear unit of movement along path 200 that is greater than 230 pixels per inch. If less time is needed to capture each image, then robot 100 may move at a faster speed. Similarly, if a more time is needed to capture each image, then robot 100 may move at a slower speed.

Robot 100 may travel at the fastest speed possible to achieve the desired horizontal pixel density (i.e. in free-run). However, prior to reaching the fastest speed possible, robot 100 accelerates and slowly builds up speed. After reaching the fastest speed possible, robot 100 may remain at a near constant speed until robot 100 nears the end of path 200 or nears a corner/turn along path 200. Near the end of path 200, robot 100 decelerates and slowly reduces its speed. During the acceleration and the deceleration periods, robot 100 may continue to capture images. However, because the speed of robot 100 at the acceleration and deceleration periods is lower, robot 100 will capture more images/vertical lines per linear unit of movement than during the period of constant speed. The additional images merely increase the horizontal pixel density and do not prevent from decoding any product identifiers that need to be identified.

In addition to capturing the series of images, robot 100 may also store the location along path 200 at which each image is captured in a database in association with the captured image. The location data may then be correlated with product identifiers on shelves 110. A map may then be created providing a mapping between identified products and their locations on shelves 110.

Robot 100 may capture a series of images on a routine basis (e.g. on a daily or weekly basis), and the combined images from each day/week analyzed relative to one another (using software analytic tools or by other means) to provide data to management teams, including but not limited to, data identifying responsiveness of sales to changes in product placement along the shelves, proper pricing of items on shelves, data identifying profit margins for each shelf, data identifying popular shelves, and data identifying compliance or non-compliance with retail policies.

FIG. 5F illustrates an example combined image created using an example robot 100 having three imaging systems 150 installed therein. In this example, robot 100 has a top level imaging system configured to capture a series of images 610 of a top portion of shelves 110, a series of images 620 of a middle portion of shelves 110, and series of images 630 of a bottom portion of shelves 110. The vertical field of view of each of the imaging systems may be limited relative to the height of shelves 110. Accordingly, multiple imaging systems may be stacked on top of one another inside robot 100, thereby enabling robot 100 to capture multiple images concurrently. In this example, at each location (x1, x2 . . . x7) along path 200, robot 100 captures three images (i.e. images 611, 621, and 631 at location x1, images 612, 622, and 632 at location x2, . . . and images 617, 627, and 637 at location x7). The images are then all combined to create a single combined image having an expanded resolution along both the vertical and horizontal axes.

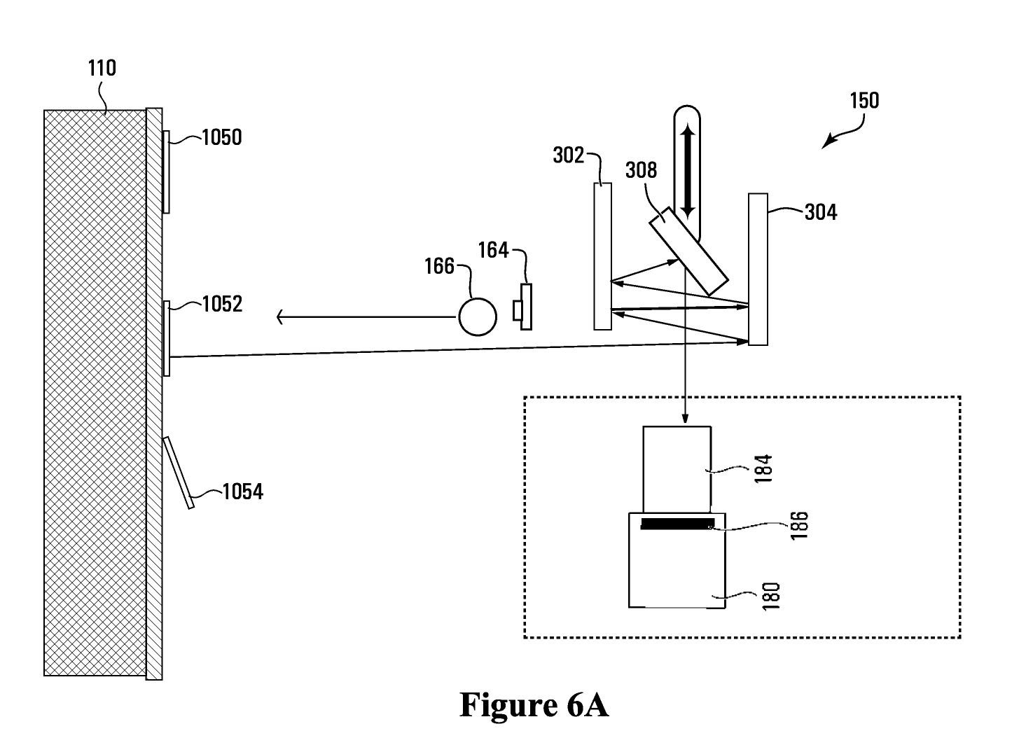

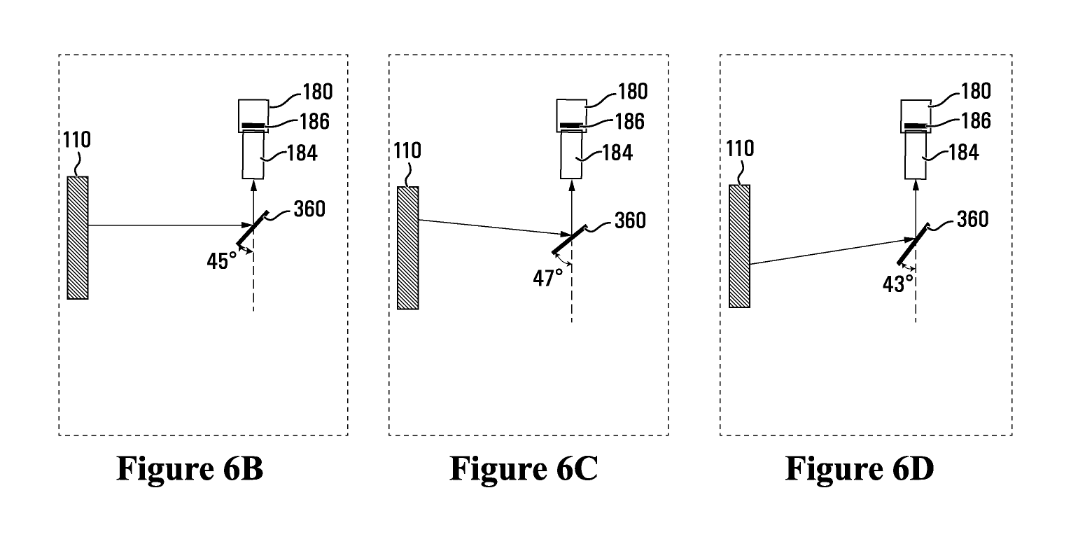

FIGS. 6A-6D illustrate the components of imaging system 150 in operation. As shown in FIG. 6A, light from light elements 164 is focused onto objects along the path through lens 166. Light reflected from objects adjacent to the path enters imaging system 150, and reflects in a zig-zag between mirrors 302, 304, as previously described until the light ray is incident on angled mirror 308, which reflects the light toward line scan camera 180.

As shown in FIGS. 6B-6D, the imaging system of FIG. 6A also includes a prism 360 positioned in the light path, such that the light ray is incident on prism 360 prior to entering line scan camera 180. Prism 360 is mounted to a rotary (not shown) which allows for adjustment of the angle of prism 360. When prism 360 is at a 45 degree angle with respect to the reflected light, the light is further reflected into line scan camera 180. As shown in FIG. 6B, while prism 360 is at a 45 degree angle with respect to the reflected light, the field of view captured by line scan camera 180 is at the same height as line scan camera 180. However, as shown in FIG. 6C a slight variation of the angle of prism 360 (e.g. 47 degrees) alters the field of view of line scan camera 180 to a field of view which is directed at objects above the camera; thereby allowing line scan camera 180 to capture an image of objects that are at a higher height relative to the camera. Similarly, as shown in FIG. 6D a slight variation of the angle of prism 360 in the opposite direction (e.g. 43 degrees) alters the field of view of line scan camera 180 to a field of view which is directed at objects below the camera; thereby allowing line scan camera 180 to capture an image of objects that are at a lower height relative to the camera. In effect, a different set of light rays are reflected onto sensor 186 of line scan camera 180.

Shifting the field of view of line scan camera 180 downwardly or upwardly may be useful in circumstances where an object is outside the normal field of line scan camera 180. One example circumstance is to capture an image of a product identifier, such as a UPC code that is on a low or high shelf. For example, also shown in FIG. 6A is a side view of shelves 110 having three shelf barcodes, a top shelf barcode 1050, a middle shelf barcode 1052, and a bottom shelf barcode 1054. As shown, top and middle shelf barcodes 1050 and 1052 are oriented flat against shelf 110. Bottom shelf barcode 1054 is oriented at an upward angle to allow for shoppers to see the barcode without leaning down. Scanning bottom shelf barcode 1054 using a line scan camera positioned at a similar height to the bottom shelf may result in a distorted image of bottom shelf barcode 1054. Accordingly, the angle of prism 360 may be adjusted by controller 120 to allow for an imaging system positioned higher relative to the bottom shelf to capture an image of bottom shelf barcode 1054. In one embodiment, the prism 360 is angled at 47 degrees with respect to the reflected light to allow robot 100 to capture an image of bottom shelf barcode 1054 that is angled upwardly.

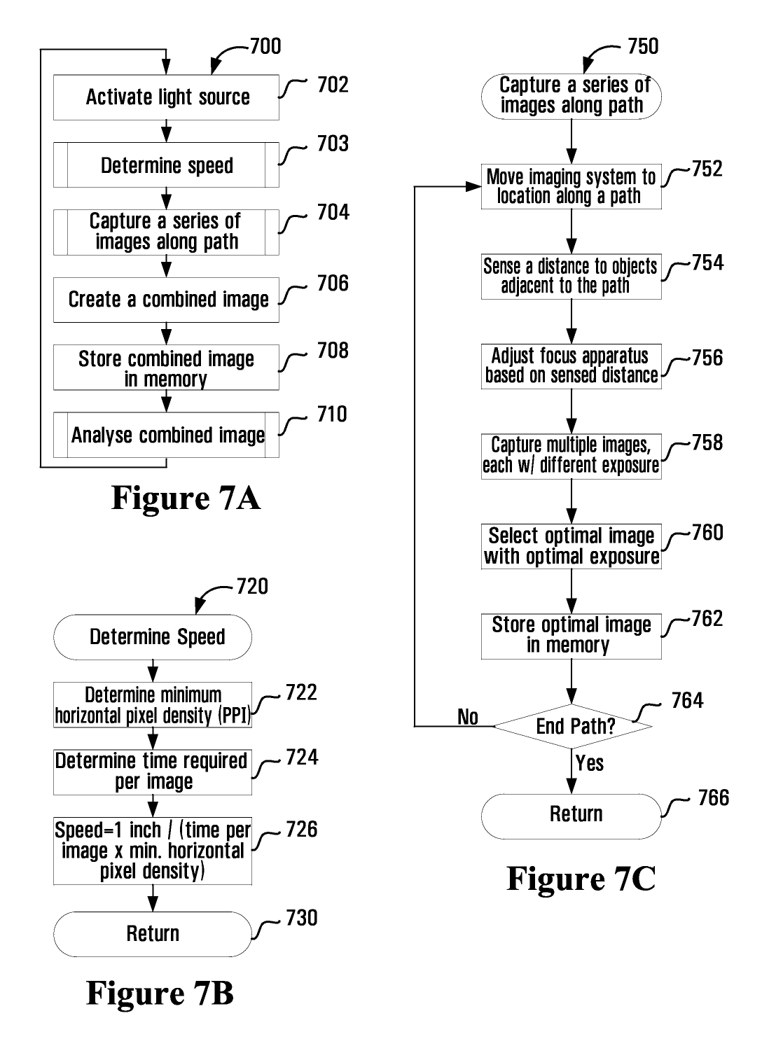

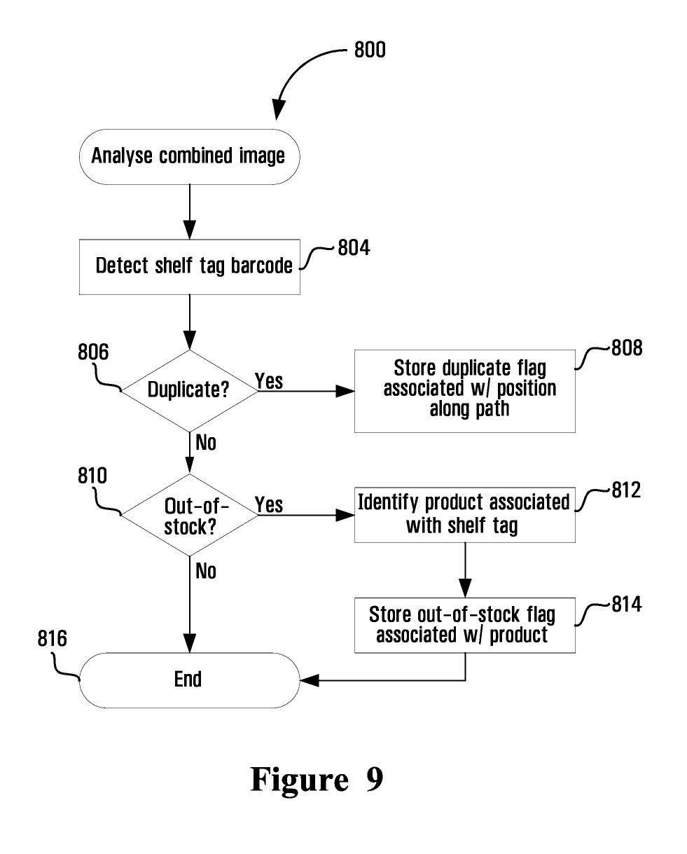

The operation of robot 100 may be managed using software such as conveyance application 132, imaging application 134, and analytics application 136 (FIG. 2). The applications may operate concurrently and may rely on one another to perform the functions described. The operation of robot 100 is further described with reference to the flowcharts illustrated in FIGS. 7A-7C, and 9, which illustrate example methods 700, 720, 750, and 800, respectively. Blocks of the methods may be performed by controller 120 of robot 100, or may in some instances be performed by a second controller (which may be external to robot 100). Blocks of the methods may be performed in-order or out-of-order, and controller 120 may perform additional or fewer steps as part of the methods. Controller 120 is configured to perform the steps of the methods using known programming techniques. The methods may be stored in memory 124.

Reference is now made to FIG. 7A, which illustrates example method 700 for creating a combined image of the objects adjacent to path 200. In one example, path 200 defines a path that traverses shelving units having shelves 110, as described above. Accordingly, the combined image may be an image of shelves 110 and the objects placed thereon (as shown in FIGS. 5A).

At 702, controller 120 may activate light source 160 which provides illumination that may be required to capture optimally exposed images. Accordingly, light source 160 is typically activated prior to capturing an image. Alternatively, an image may be captured prior to activating light source 160 then analyzed to determine if illumination is required, and light source 160 may only be activated if illumination is required.

The maximum speed at which robot 100 may traverse path 200 may correspond with the time required to capture each image of the series of images 210, and the minimum horizontal pixel density per linear unit of path 200 required to decode a product identifier. Robot 100 may be configured to move along path 200 at a constant speed without stopping at each location (i.e. x1, x2, x3, x4, x5, and so forth) along path 200. At 703, controller 120 may determine a maximum speed at which the robot 100 may move along path 200 to capture in excess of a predefined number of vertical lines per linear unit of movement of robot 100 along path 200 to allow the images to be combined to form the combined image having a horizontal pixel density greater than a predefined pixel density. After determining the maximum speed robot 100 may travel at any speed lower than the maximum speed along path 200. Example steps associated with block 703 are detailed in example method 720.

At 704, controller 120 may cause robot 100 to move along path 200, and may cause imaging system 150 to capture a series of images 210 of objects adjacent to path 200 (as shown in FIG. 5D-5F) as robot 100 moves along path 200. Each image of the series of images 210 corresponds to a location along path 200 and has at least one column of pixels. Example steps associated with block 704 are detailed in example method 750.

At 706, controller 120 may combine the series of images 210 to create a combined image of the objects adjacent to path 200. The combined image may be created using known image stitching techniques, and has a series of columns of pixels. At 708, controller 120 may store the combined image in memory 124, for example, in a database. Controller 120 may also associate each image with a timestamp and a location along path 200 at which the image was captured. At 710, controller 120 may analyze the combined image to determine any number of events related to products on shelves 110, including but not limited to, duplicated products, out-of-stock products, misplaced products, mispriced products, and low inventory products. Example steps associated with block 710 are detailed in example method 800.

Alternatively, in some embodiments, controller 120 sends (e.g. wirelessly via communication subsystem 122) each image of the series of images 210 and/or the combined image to a second computing device (e.g. a server) for processing and/or storage. The second computing device may create the combined image and/or analyze the combined image for events related to products on shelves 110. The second computing device may also store in memory each image of the series of images 210 and/or the combined image. This may be helpful to reduce the processing and/or storage requirements of robot 100.

FIG. 7B illustrates example method 720 for determining the maximum speed at which the robot 100 may move along path 200 to capture images of the series of images 210 along path 200 to acquire in excess of a predefined number of vertical lines per linear unit of movement of robot 100 along path 200 to allow the images to be combined to form a combined image having a horizontal pixel density greater than a predefined pixel density. Method 720 may be carried out by controller 120 of robot 100.

At 722, controller 120 identifies the type of product identifier (e.g. UPC, text, imagery, ect.) that robot 100 is configured to identify. For each type of product identifier, robot 100 may store in memory a value for a minimum horizontal pixel density per linear unit of path 200. The value for the minimum horizontal pixel density per linear unit of movement along path 200 is typically expressed in pixels per inch (‘PPI’), and reflects the number of captured pixels needed per linear unit of movement of robot 100 to allow for the product identifier to be adequately decoded from the image.

At 724, controller 120 may also determine the time required to capture each image. The time required may vary in dependence, in part, on the exposure time, and whether focus blocks and/or exposure blocks are enabled or omitted. Controller 120 may access from memory average times required to capture each image based on the configuration of the imaging settings. If the exposure blocks are enabled (where multiple images are captured, each with a different exposure), then the time required to capture each sequence of images may be used instead, as only one image of each sequence is used for creating the combined image.

At 726, controller 120 may compute the maximum speed at which robot 100 may move along path 200 based on minimum horizontal pixel density required for to decode a specific type of product identifier, and the time needed to capture each image (or sequence). In particular, since the pixel density is usually expressed in pixels per inch, the speed in inches per second is equal to 1/(time in seconds required to capture one image or sequence×the minimum horizontal pixel density). At 730, method 720 returns to block 704 of method 700.

Reference is now made to FIG. 7C, which illustrates example method 750 for capturing a series of images of the objects adjacent to path 200. At 752, controller 120 may control robot 100 to convey to a first location x1 along path 200 (as shown in FIGS. 5D-5F). Robot 100 moves along path 200, to which imaging system 150 is coupled. Because the distance between objects and line scan camera 180 may vary (e.g. because the shelves are not fully stocked) as robot 100 moves along path 200, blocks 754-756 relate to adjusting focus apparatus 170. Accordingly, as robot 100 moves along path 200, at 754-756, controller 120 may adjust focus apparatus 170. The focus blocks may also be omitted entirely from method 750 (e.g. if no focus apparatus is present in robot 100, or if adjusting the focus is not necessary, e.g. if a lens with a small aperture and large DOF is used), or may be omitted from only some locations along path 200. For example, in some embodiments, focus apparatus 170 may be adjusted only for the first image of a series of images along path 200.

At 754, controller 120 may cause depth sensor 176 to sense a distance between depth sensor 176 and objects adjacent to path 200. Depth sensor 176 may produce an output indicating the distance between depth sensor 176 and the objects along path 200, which may be reflective of the distance between line scan camera 180 and the objects due to the placement and/or the calibration of depth sensor 176. At 756, controller 120 may adjust focus apparatus 170 prior to capturing a series of images 210 based on the distance sensed by depth sensor 176 and the DOF of lens 184 (controller 120 may adjust focus apparatus 170 less frequently when lens 184 has a deep DOF). Focus apparatus 170 may maintain a working distance between line scan camera 180 and the objects substantially constant to bring the objects in focus (i.e. to bring the shelves 110 in focus, as previously explained).

Also, because the optimal exposure for each location along path 200 may vary (e.g. based on the objects at the location—bright objects may require lower exposure than dark objects), blocks 758-760 relate to capturing and selecting an image having an optimal illumination. The exposure blocks may however be omitted entirely from method 750, or may be omitted from only some locations along path 200, for example, to reduce image capturing and processing time/requirements.

At 758, controller 120 may cause line scan camera 180 to capture a series of sequences of images of the objects along path 200 as robot 100 moves along the path. Each image of each of the sequences of images has a predefined exposure value that varies between a high exposure value and a low exposure value. Controller 120 may then, at 760, for each sequence of images, select an image of the sequence having no saturated pixels, to obtain a series of selected images. Controller 120 may then combine the series of selected images to create a combined image of the objects adjacent to path 200 at 706.

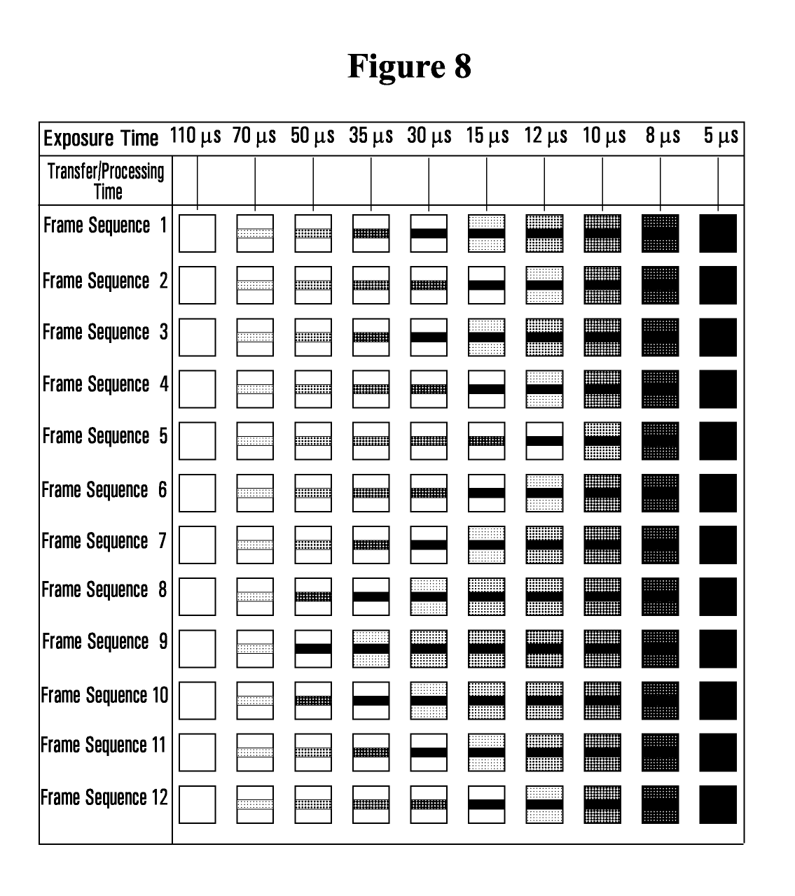

At 758, controller 120 may vary the exposure of each image in each sequence in accordance with an exposure pattern. Reference is made to FIG. 8, which illustrates an example exposure pattern and the effect of varying the exposure time on captured pixels. For images captured using long exposure times, black pixels may appear white, and similarly, for images captured using short exposure times, white pixels may appear black. In one example, each image in the sequence is acquired using predefined exposure time, followed by a 5 μs pause, in accordance with Table 1. Ten images are acquired for each sequence, then controller 120 restarts the sequence. The first image of the sequence of Table 1 has an exposure time of 110 μs, and the tenth and final image of the sequence has an exposure time of 5 μs. In total, each exposure sequence requires 390 is to complete.

TABLE 1

| Image Number | |
|---|---|
| in Sequence | Exposure Time (μs) |
| 1 | 110 (high exposure) |
| 2 | 70 |
| 3 | 50 |
| 4 | 35 |
| 5 | 30 |
| 6 | 15 |
| 7 | 12 |
| 8 | 10 |
| 9 | 8 |
| 10 | 5 (low exposure) |

Controller 120 may control line scan camera 180 to adjust the exposure settings by varying the aperture of lens 184, by varying the sensitivity (ISO) of image sensor 186, or by varying an exposure time of line scan camera 180 (amongst others). Additionally, varying light source 160 may adjust the exposure settings by varying the intensity of the light elements of the array.

At 760, after capturing each sequence of images, with each image in the sequence having a different exposure, controller 120 may select an image having an optimal exposure. To select the image having the optimal exposure, controller 120 may identify an image of the multiple images that is not over-saturated. Over-saturation of an image is a type of distortion that results in clipping of the colors of pixels in the image; thus, an over-saturated image contains less information about the image. To determine if an image is over-saturated, the pixels of the image are examined to determine if any of the pixels have the maximum saturation value. If an image is determined to be over-saturated, an image having a lower exposure value is selected (e.g. using a shorter exposure time). An optimal image is an image having the highest exposure value and having no oversaturated pixels.

Because the first image has the longest exposure time, there is a likelihood that the resulting image will be overexposed/over saturated. Such an image would not be ideal for inclusion in the combined image, as it would not help in decoding a product identifier. Similarly, the last image has the shortest exposure time, resulting in a high likelihood that the resulting image will be underexposed/under saturated. Such an image would also not be ideal for inclusion in the combined image, as it would not help in decoding a product identifier. Accordingly, an image from the middle of the sequence is most likely to be selected.

In the example shown, only one image of each ten images associated with each sequence is selected for inclusion in the combined image. Accordingly, to compute the maximum speed at which robot 100 may travel to obtain a combined image having a horizontal pixel density greater than the predefined horizontal pixel density, robot 100 may consider the time to capture each image as being equal to the time required to capture an entire sequence of images. This results in a slower moving robot that captures ten times as many images as needed to obtain the desired horizontal pixel density. However, by capturing a sequence and selecting only an optimally exposed image for inclusion in the combined image, the likelihood that any portion of the combined image is over or under exposed may be reduced.

For example, for the frame sequences of FIG. 8, controller 120 may use the longest exposure time (i.e. in the example given, 110 μs) as the time to capture each image (although substantially the same image is captured at different exposures is captured 10 times).

At 762, controller 120 may store the image having the optimal exposure in memory 124. Alternatively, controller 120 may store all the captured images and select the image having the optimal exposure at a later time. Similarly, if only one image was captured in each sequence, then controller 120 may store that image in memory 124.

At 764, controller 120 may determine if path 200 has ended. Path 200 ends if robot 100 traversed from the start to end of every portion of path 200. If path 200 has ended, method 750 returns at 766 to block 706 of method 700. If path 200 has not ended, method 750 continues operation at block 752. If method 750 continues operation at block 752, controller 120 may cause robot 100 to convey to a second location x2 that is adjacent to first location x1 along path 200 and to capture second image 212. In operation, robot 100 may move along path 200 continuously without stopping as the imaging system 150 captures images. Accordingly, each location along path 200 is based on the position of robot 100 at the time at which controller 120 initiates capture of a new image or a new sequence of images.

Reference is now made to FIG. 9, which illustrates example method 800 for analyzing a combined image to determine any number of events related to products on shelves 110, including but not limited to, duplicate products, errors, mislabeled products and out-of-stock products, etc. As previously explained, the method 800 may be carried out by controller 120 or by a processor of a second computing device.

Since path 200 traverses shelves 110, the combined image includes an image of shelves 110 of the shelving unit and other objects along path 200 which may be placed on shelves 110. Such objects may include retail products, which may be tagged with barcodes uniquely identifying the products. Additionally, each of the shelves 110 may have shelf tag barcodes attached thereto. Each shelf tag barcode is usually associated with a specific product (e.g. in a grocery store, Lays® Potato Chips, Coca-Cola®, Pepsi®, Christie® Cookies, and so forth). Accordingly, at 804, controller 120 may detect the shelf tag barcodes in the combined image by analyzing the combined image. For example, controller 120 may search for a specific pattern that is commonly used by shelf tag barcodes. Each detected shelf tag barcode be added as meta-data to the image, and may be further processed for correction therewith.

Additionally, the placement of each shelf tag barcode indicates that the specific product is expected to be stocked in proximity to the shelf tag barcode. In some retail stores it may be desirable to avoid storing the same product at multiple locations. Accordingly, at 806, controller 120 may determine whether a detected shelf tag barcode duplicates another detected shelf tag barcode. This would indicate that the product associated with the detected shelf tag barcode is stored at multiple locations. If a detected shelf tag barcode duplicates another detected shelf tag barcode, controller 120 may store in memory 124, at 808, an indication that the shelf tag bar code is duplicate. Additionally, the shelf tag barcode may also be associated with a position along path 200, and controller 120 may store in memory 124 the position along the path associated with the detected shelf tag barcode to allow personnel to identify the location of the duplicated product(s).

It may also be desirable to store information regarding out-of-stock and/or low-in-stock products. Accordingly, at 810, controller 120 may determine if the shelves 110 of the shelving unit are devoid of product. In one embodiment, as robot 100 traverses path 200, controller 120 may detect, using depth sensor 176, a depth associated with different products stored on shelves 110 in proximity to a shelf tag barcode. Controller 120 may then compare the detected depth to a predefined expected depth. If the detected depth is less that the expected depth by a predefined margin, then the product may be out-of-stock, or low-in-stock. As noted, depth data may be stored in relation to different positions along path 200, and cross-referenced by controller 120 to shelf tag barcodes in the combined image to determine a shelf tag barcode associated with each product that may be out-of-stock or low-in-stock. At 812, controller 120 may then identify each product that may be out-of-stock or low-in-stock by decoding the shelf tag barcode associated therewith. For each product that may be out-of-stock or low-in-stock, at 814, controller 120 may store, in memory 124, an indication that the product is out-of-stock or low-in-stock, respectively.

If controller 120 determines that no shelves 110 of shelving unit are devoid of product, method 800 ends at 816 and need not store an out-of-stock nor a low-in-stock indication.

Of course, the above described embodiments are intended to be illustrative only and in no way limiting. The described embodiments are susceptible to many modifications of form, arrangement of parts, details and order of operation. Software implemented in the modules described above could be implemented using more or fewer modules. The invention is intended to encompass all such modification within its scope, as defined by the claims.

What is claimed is:

1. A robot comprising:
a conveyance apparatus for moving the robot along a path;
a line scan camera mounted to the robot and configured to move as the robot moves; and
a controller communicatively coupled to the conveyance apparatus and to the line scan camera and configured to
control the robot to move, using the conveyance apparatus, along the path,
capture, using the line scan camera, a series of images of objects along the path as the robot moves, each image of the series of images having at least one vertical line of pixels, and
control the speed of the robot and the line scan camera, to acquire in excess of a predefined number of vertical lines of pixels per linear unit of movement of the robot along the path, to allow the images to be combined to form a combined image having a horizontal pixel density greater than a predefined pixel density.

2. The robot of claim 1, further comprising a focus apparatus having a first mirror, a second mirror opposing the first mirror and defining an optical cavity therein, and a third mirror angled to direct light to the line scan camera and disposed between the first mirror and the second mirror, wherein at least one of the mirrors is movable to alter the path of the light travelling from the objects along the path to the line scan camera.

3. The robot of claim 2, wherein the objects along the path are at varying distances from the line scan camera, and wherein the controller is further configured to control the movable mirror to maintain a substantially constant working distance between the line scan camera and the objects adjacent to the path as the robot moves.

4. The robot of claim 3, further comprising a depth sensor for sensing a distance between the depth sensor and the objects adjacent to the path, and wherein the controller is configured to adjust the movable mirror based on an output from the depth sensor.

5. The robot of claim 4, wherein the depth sensor is a time-of-flight camera.

6. The robot of claim 3, wherein light entering the focus apparatus is reflected between the first mirror and the second mirror across the optical cavity and intersects the third mirror and is thereby reflected onto an image sensor of the line scan camera.

7. The robot of claim 6, wherein at least one of the distances between the first mirror and the second mirror, the distance between the third mirror and the image sensor of the line scan camera, and the angle of the any one of the first, second, and third mirrors is adjustable to maintain the working distance between the line scan camera and the objects adjacent to the path substantially constant.

8. The robot of claim 1, further comprising an array of lights having light elements placed adjacent to one another along the height of the robot, and having a lens configured to direct light from the light elements towards the objects adjacent to the path.

9. The robot of claim 8, wherein the lens is configured to converge light rays from the light elements onto a field of view of the line scan camera.

10. The robot of claim 1, wherein the controller is configured to
capture, using the line scan camera, a series of sequences of images of objects along the path as the robot moves, each image of each of the sequences of images having one of a plurality of predefined exposure values, the predefined exposure values varying between a high exposure value and a low exposure value,
for each of the sequences of images, select an image of the sequence having no saturated pixels, to obtain a series of selected images, and
combine the series of selected images to create a combined image of the objects adjacent to the path.

11. A robot comprising:
a conveyance apparatus for moving the robot along a path;
a line scan camera mounted to the robot and configured to move as the robot moves;
a focus apparatus having a first mirror, a second mirror opposing the first mirror and defining an optical cavity therein, and a third mirror angled to direct light to the line scan camera and disposed between the first mirror and the second mirror, wherein at least one of the mirrors is movable to alter the path of the light travelling from the objects along the path to the line scan camera; and
a controller communicatively coupled to the conveyance apparatus, the line scan camera, and the focus apparatus, and configured to control the robot to move, using the conveyance apparatus, along the path, capture, using the line scan camera, a series of images of objects along the path as the robot moves, the objects along the path being at varying distances from the line scan camera, and control the movable mirror to maintain a substantially constant working distance between the line scan camera and the objects adjacent to the path as the robot moves.

12. The robot of claim 11, further comprising a depth sensor for sensing a distance between the depth sensor and the objects adjacent to the path, and wherein the controller is configured to adjust the movable mirror based on an output from the depth sensor.

13. The robot of claim 12, wherein the depth sensor is a time-of-flight camera.

14. The robot of claim 11, wherein light entering the focus apparatus is reflected between the first mirror and the second mirror across the optical cavity and intersects the third mirror and is thereby reflected onto an image sensor of the line scan camera.

15. The robot of claim 14, wherein at least one of the distance between the first mirror and the second mirror, the distance between the third mirror and the image sensor of the line scan camera, and the angle of the any one of the first, second, and third mirrors is adjustable to maintain the working distance between the line scan camera and the objects adjacent to the path substantially constant.

16. The robot of claim 11, further comprising an array of lights having light elements placed adjacent to one another along the height of the robot, and having a lens configured to direct light from the light elements towards the objects adjacent to the path.

17. The robot of claim 16, wherein the lens is configured to converge light rays from the light elements onto a field of view of the line scan camera.

18. The robot of claim 11, wherein the controller is configured to
capture, using the line scan camera, a series of sequences of images of objects along the path as the robot moves, each image of each of the sequences of images having one of a plurality of predefined exposure values, the predefined exposure values varying between a high exposure value and a low exposure value,
for each of the sequences of images, select an image of the sequence having no saturated pixels, to obtain a series of selected images, and
combine the series of selected images to create a combined image of the objects adjacent to the path.

19. The robot of claim 11, wherein the controller is configured to
combine the series of images to create a combined image of the objects adjacent to the path, the combined image having a series of vertical lines of pixels, and
control the speed of the robot and the line scan camera, to acquire in excess of a predefined number of vertical lines of pixels per linear unit of movement of the robot along the path, to allow the images to be combined to form the combined image having a horizontal pixel density greater than a predefined pixel density.

20. A robot comprising:
a conveyance for moving the robot along a path;
a line scan camera mounted to the robot and configured to move as the robot moves; and
a controller communicatively coupled to the conveyance and to the line scan camera and configured to
control the robot to move, using the conveyance, along the path,
capture, using the line scan camera, a series of sequences of images of objects along the path as the robot moves, each image of each of the sequences of images having one of a plurality of predefined exposure values, the predefined exposure values varying between a high exposure value and a low exposure value,
for each of the sequences of images, select an image of the sequence having no saturated pixels, to obtain a series of selected images, and
combine the series of selected images to create a combined image of the objects adjacent to the path.

21. The robot of claim 20, wherein the controller is configured to control the speed of the robot and the line scan camera, to acquire in excess of a predefined number of vertical lines per linear unit of movement of the robot along the path, to allow the images to be combined to form the combined image having a horizontal pixel density greater than a predefined pixel density.

22. The robot of claim 20, further comprising a focus apparatus having a first mirror, a second mirror opposing the first mirror and defining an optical cavity therein, and a third mirror angled to direct light to the line scan camera and disposed between the first mirror and the second mirror, wherein at least one of the mirrors is movable to alter the path of the light travelling from the objects along the path to the line scan camera.

23. The robot of claim 22, wherein the objects along the path are at varying distances from the line scan camera, and wherein the controller is further configured to control the movable mirror to maintain a substantially constant working distance between the line scan camera and the objects adjacent to the path as the robot moves.

24. The robot of claim 23, further comprising a depth sensor for sensing a distance between the depth sensor and the objects adjacent to the path, and wherein the controller is configured to adjust the movable mirror based on an output from the depth sensor.

25. The robot of claim 24, wherein the depth sensor is a time-of-flight camera.

26. The robot of claim 22, wherein light entering the focus apparatus is reflected between the first mirror and the second mirror across the optical cavity and intersects the third mirror and is thereby reflected onto an image sensor of the line scan camera.

27. The robot of claim 26, wherein at least one of the distance between the first mirror and the second mirror, the distance between the third mirror and the image sensor of the line scan camera, and the angle of the any one of the first, second, and third mirrors is adjustable to maintain the working distance between the line scan camera and the objects adjacent to the path substantially constant.

28. The robot of claim 20, further comprising an array of lights having light elements placed adjacent to one another along the height of the robot, and having a lens configured to direct light from the light elements towards the objects adjacent to the path.

29. The robot of claim 28, wherein the lens is configured to converge light rays from the light elements onto a field of view of the line scan camera.

30. A method for capturing an image using a line scan camera coupled to a robot, the method comprising:
controlling the robot to move, using a conveyance, along a path;
capturing, using the line scan camera, a series of images of objects along the path as the robot moves, each image of the series of images having at least one vertical line of pixels; and
controlling the speed of the robot and the line scan camera, to acquire in excess of a predefined number of vertical lines of pixels per linear unit of movement of the robot along the path, to allow the images to be combined to form a combined image having a horizontal pixel density greater than a predefined pixel density.

31. The method of claim 30, wherein the robot has a focus apparatus mounted adjacent to the line scan camera, the method further comprising:
sensing, using a depth sensor, a distance between the depth sensor and the objects adjacent to the path; and
prior to capturing the series of images, adjusting the focus apparatus based on the sensed distance to maintain a working distance between the line scan camera and the objects adjacent to the path to bring the objects adjacent to the path in focus substantially constant.

32. The method of claim 30, further comprising
capturing, using the line scan camera, a series of sequences of images of objects along the path as the robot moves, each image of each of the sequences of images having one of a plurality of predefined exposure values, the predefined exposure values varying between a high exposure value and a low exposure value;
for each of the sequences of images, selecting an image of the sequence having no saturated pixels, to obtain a series of selected images; and
combining the series of selected images to create the combined image of the objects adjacent to the path.

33. The method of claim 30, wherein the robot traverses a shelving unit having a plurality of shelf tag barcodes attached thereto, each shelf tag barcode being associated with a position along the path, the method further comprising:
determining whether a detected shelf tag barcode duplicates another detected shelf tag barcode; and
if a detected shelf tag barcode duplicates another detected shelf tag bar code, storing, in memory, an indication that the shelf tag bar code is duplicated.

34. The method of claim 33, further comprising, if a detected shelf tag barcode duplicates another detected shelf tag bar code, storing, in memory, the position along the path associated with the detected shelf tag barcode.

35. A robot comprising:
a conveyance apparatus for moving the robot along a path;
a camera mounted to the robot and configured to move as the robot moves and to capture a series of images of objects along the path as the robot moves;
a focus apparatus having a first mirror, a second mirror opposing the first mirror to define an optical cavity therein and positioned to receive light from the objects along the path and to redirect the light to the first mirror, and a third mirror disposed between the first mirror and the second mirror and angled to receive the light from the first mirror and to redirect the light to the line scan camera, and wherein the focus apparatus extends a working distance between the line scan camera and the objects adjacent to the path; and
a controller communicatively coupled to the conveyance apparatus and the line scan camera and configured to control the robot to move, using the conveyance apparatus, along the path, and capture, using the line scan camera, a series of images of objects along the path as the robot moves.

36. The robot of claim 35, wherein light entering the focus apparatus is reflected between the first mirror and the second mirror across the optical cavity and intersects the third mirror and is thereby reflected onto an image sensor of the line scan camera.

37. The robot of claim 36, wherein the light is reflected in a zigzag within the optical cavity.

38. The robot of claim 36, wherein the light that is reflected onto the image sensor of the line scan camera is incident at an angle that is substantially normal to the image sensor.

39. The robot of claim 35, wherein at least one of the distance between the first mirror and the second mirror, the distance between the third mirror and the image sensor of the line scan camera, and the angle of the any one of the first, second, and third mirrors is adjustable.

40. The robot of claim 35, wherein the controller is configured to control the speed of the robot and the line scan camera, to acquire in excess of a predefined number of vertical lines per linear unit of movement of the robot along the path, to allow the images to be combined to form the combined image having a horizontal pixel density greater than a predefined pixel density.

41. The robot of claim 35, further comprising an array of lights having light elements placed adjacent to one another along the height of the robot, and having a lens configured to direct light from the light elements towards the objects adjacent to the path.

42. The robot of claim 41, wherein the lens is configured to converge light rays from the light elements onto a field of view of the line scan camera.

43. The robot of claim 36, wherein the camera is a line scan camera.
